(19) United States
(12) Patent Application Publication
(10) Pub. No.: US 2025/0048465 A1
(43) Pub. Date: Feb. 6, 2025

(54) COMMUNICATION METHOD, APPARATUS, AND SYSTEM

(71) Applicant: HUAWEI TECHNOLOGIES CO., LTD., Shenzhen, Guangdong (CN)

(72) Inventors: Yali WANG, Beijing (CN); Xudong ZHANG, Shenzhen (CN); Xingqing CHENG, Beijing (CN); Jian WANG, Beijing (CN)

(21) Appl. No.: 18/919,796

(22) Filed: Oct. 18, 2024

Related U.S. Application Data
(63) Continuation of application No. PCT/CN2022/139128, filed on Dec. 14, 2022.

(30) Foreign Application Priority Data
Apr. 20, 2022 (CN) 202210420944.9

(51) Int. Cl. H04W 76/15; H04W 8/22; H04W 76/19

(52) U.S. Cl. CPC H04W 76/15; H04W 8/22; H04W 76/19

(57) ABSTRACT

The technology of this application relates to a communication method, apparatus, and system, and relates to the field of communication technologies. The method includes a first node performing data transmission with a destination node based on a first communication link, where the first communication link includes a second node. When the first communication link is unavailable, the first node performs data transmission with the destination node based on a second communication link, where the second communication link includes a third node different from the second node, and the second node and the third node belong to a destination node group. The second communication link serves as a redundant communication link of the first communication link, to provide communication support between the first node and the destination node for data transmission when the first communication link is unavailable, so as to improve communication reliability of a system.

### CROSS-REFERENCE TO RELATED APPLICATIONS

This application is a continuation of International Patent Application No. PCT/CN2022/139128, filed on Dec. 14, 2022, which claims priority to Chinese Patent Application No. 202210420944.9, filed on Apr. 20, 2022. The disclosures of the aforementioned applications are hereby incorporated by reference in their entireties.

### TECHNICAL FIELD

This application relates to the field of communication technologies, and in particular, to a communication method, apparatus, and system.

### BACKGROUND

With development of automotive electronics technologies, intelligent vehicle technologies are gradually applied, to make vehicles have simpler operating performance, higher power and economic performance, and better traveling safety. Therefore, the vehicles trend to be intelligent in the future.

However, these intelligent technologies are typically implemented by using components. When these components cannot communicate with each other, communication interaction through the components is blocked, and consequently related service data cannot be transmitted. In this case, some intelligent functions of the vehicles cannot be used.

Therefore, how to ensure communication reliability is still an important problem to be resolved.

### SUMMARY

Embodiments of this application provide a communication method, apparatus, and system, to help improve communication reliability of a communication system.

According to a first aspect, an embodiment of this application provides a communication method. The method may be applied to a first node in a communication system, and the communication system may further include a destination node. The method may include:

A first node performs data transmission with a destination node based on a first communication link, where the first communication link includes a second node; and
when the first communication link is unavailable, the first node performs data transmission with the destination node based on a second communication link different from the first communication link, where the second communication link includes a third node different from the second node, the second node and the third node belong to a destination node group, and a node included in the destination node group is configured to establish a communication connection for the first node and the destination node.

According to the foregoing method, communication nodes in a communication system may be abstracted as a redundant communication networking architecture. In the architecture, the first communication link between the first node and the destination node may have a redundant communication link, for example, the second communication link, and nodes included in the first communication link and the second communication link may be different or not be completely the same. When an unavailability problem occurs on the first communication link, for example, when a node included in the first communication link is unavailable or a communication sublink of the first communication link is unavailable, the first node may continue to perform data transmission through the second communication link. This improves reliability and stability of the entire communication system.

It may be understood that, in embodiments of the first aspect of this application, the first node may be a source node of data, the source node may be configured to provide data (for example, service data and/or control signaling) for the destination node through at least one communication link, and the nodes included in each of the first communication link and the second communication link include a routing node located between the source node and the destination node on the at least one communication link. Alternatively, the first node may be any node configured to perform data communication with the destination node, and data transmission may be performed between the first node and the destination node through at least one communication link. The first communication link and the second communication link in the at least one communication link may be mutually redundant communication links, to ensure reliability of the communication system.

It should be noted that, in embodiments of this application, different nodes on the first communication link/second communication link may communicate and interact with each other in at least one communication manner, including but not limited to wired communication and/or wireless communication. The nodes on the first communication link/the second communication link may have different product forms based on an application scenario or an implemented service. This is not limited in embodiments of this application. That the nodes included in the first communication link and the second communication link are different may be understood as that there is at least one different node between the nodes included in the first communication link and the nodes included in the second communication link.

With reference to the first aspect, in a possible implementation, that the first communication link is unavailable is represented by at least one of the following:
the second node is unavailable;
in the first communication link, a communication sublink between the first node and the second node is unavailable; and
in the first communication link, a communication sublink between the second node and the destination node is unavailable.

According to the foregoing method, the second node indicates any routing node located between the first node and the destination node on the first communication link. If the routing node is unavailable or a communication sublink based on the routing node is unavailable, the first communication link is unavailable. Therefore, both of the two cases belong to the case in which the first communication link is unavailable in embodiments of this application, so that the first node is triggered to perform data transmission with the destination node based on the second communication link.

It may be understood that, in embodiments of the first aspect of this application, the first node represents a communication node concerned in the communication system. Therefore, when the case in which the first communication link is unavailable is considered, whether there is an unavailable second node on the first communication link is mainly concerned, or whether a communication sublink associated with the second node is available is considered. The case in which the first communication link is unavailable is not limited.

It should be noted that, that the second node is unavailable may include but is not limited to that the second node is faulty or that the second node is offline (for example, sleep or shut down), and that the communication sublink between the first node and the second node is unavailable may include but is not limited to that the communication sublink is disconnected, or service quality of the communication sublink is lower than a predetermined threshold. That the communication sublink between the second node and the destination node is unavailable may include but is not limited to that the communication sublink is disconnected, or service quality of the communication sublink is lower than a predetermined threshold. An implementation in which the second node is unavailable, the communication sublink between the first node and the second node is unavailable, or the communication sublink between the second node and the destination node is unavailable is not limited in embodiments of this application.

In embodiments of this application, the third node indicates any routing node located between the first node and the destination node on the second communication link. The second node and the third node may belong to the destination node group, and the second node and the third node are mutually redundant communication nodes. Therefore, when the second node is unavailable or a communication sublink based on the second node is unavailable, a communication sublink based on the third node may be used to perform data transmission between the first node and the destination node, to ensure communication reliability of the communication system. Alternatively, when the third node is unavailable or the communication sublink based on the third node is unavailable, the communication sublink based on the second node may be used to perform data transmission between the first node and the destination node, to ensure communication reliability of the communication system.

Different nodes in the destination node group may have a same role in the communication system and are configured to implement a same function, or different nodes may have different roles in the communication system and are configured to implement different functions.

For example, a working mode of the destination node group may include an active-standby mode. In the active-standby mode, the second node and the third node may have different functional roles and are configured to implement different functions. For example, the second node is an active node, the third node is a standby node, and when data transmission is performed between the first node and the destination node based on the first communication link to which the active node belongs, the second communication link based on the standby node is not established, and the second communication link is used as a redundant communication link of the first communication link. When the first communication link is unavailable, the second communication link may be established and used for data transmission between the first node and the destination node.

For another example, the working mode of the destination node group may include an active-active mode. In the active-active mode, the second node and the third node have a same role and are configured to implement a same function. For example, both the first communication link based on the second node and the second communication link based on the third node are established. When the first node performs data transmission with the destination node based on the first communication link, the first node may perform redundant data transmission with the destination node based on the second communication link. In other words, information transmitted based on the second communication link is the same as information transmitted based on the first communication link. When the first communication link is unavailable, the first node may still perform data transmission with the destination node based on the second communication link, without affecting continuity of service transmission. Alternatively, when the first node performs data transmission with the destination node based on the first communication link, the second communication link may be idle (that is, not occupied) and is not used for redundant data transmission. When the first communication link is unavailable, the first node may continue to perform data transmission with the destination node based on the second communication link, without affecting continuity of service transmission.

It may be understood that, in embodiments of this application, the roles of the second node and the third node may be exchanged. For example, in the active-standby mode, the third node may be the active node, and the second node may be the standby node. When the second communication link is unavailable but the first communication link is available, the first node may perform data transmission with the destination node based on the first communication link. In the active-active mode, both the first communication link and the second communication link are established. When the second communication link is unavailable but the first communication link is available, the first node may perform data transmission with the destination node based on the first communication link. The active-standby mode and the active-active mode are merely examples for description of the working mode of the destination node group in embodiments of this application, but are not any limitation. In another embodiment, the destination node group may alternatively be in another working mode.

It should be noted that in embodiments of this application, one node group may include at least two nodes, and the nodes included in the destination node group may not be limited to the second node and the third node. A relationship between a node and a node group may be preconfigured. Different nodes may perform a device discovery process based on configuration information of the nodes, to determine whether the nodes belong to a same node group. An identity negotiation process may be performed between nodes that belong to the same node group, to negotiate and determine a working mode of the node group and an identity of each node in the node group. When the working mode of the node group and the identity of each node in the node group are determined, different nodes in the node group may establish links with a node (for example, the first node and the destination node) outside the node group based on a requirement and perform data transmission.

With reference to the first aspect, in a possible implementation, the working mode of the destination node group is the active-standby mode, and the method may further include:

The first node receives first indication information from the third node, where the first indication information is used to request to switch an active-standby state for the third node; and
when determining to allow the third node to switch from a standby node to an active node, the first node sends a connection request message to the third node, where the connection request message is used to request to establish a communication sublink with the third node, and the second communication link includes the communication sublink between the first node and the third node.

According to the foregoing method, the second node may indicate the active node, the third node may represent the standby node, and the standby node may be configured to monitor a status of the active node, to determine whether the active node is available. When the standby node determines that the current active node is unavailable, the standby node may actively send the first indication information to the first node, to request to switch the active-standby state for the standby node. That is, the third node currently used as the standby node requests to switch to the active node, to replace the second node for data transmission. The first node may make a control decision based on the first indication information from the third node, to determine whether to allow the third node to switch from the standby node to the active node. When determining to allow the third node to switch from the standby node to the active node, the first node may establish a link with the third node by sending a connection request message to the third node, and perform data transmission based on the established communication sublink included in the second communication link.

It should be noted that, in embodiments of this application, the active node and the standby node in a same node group may maintain an active-standby relationship by exchanging active-standby heartbeat packets. For example, the standby node may determine that the active node is unavailable when the standby node cannot receive a heartbeat packet (or cannot receive a complete packet) from the active node. An implementation in which the standby node discovers whether the active node is unavailable is not limited in embodiments of this application.

With reference to the first aspect, in a possible implementation, the first indication information may include a group identifier of the destination node group and a round number of the third node used for active node election.

According to the foregoing method, for example, the standby node in the destination node group may be elected to be the active node in an election manner. The first indication information may carry election information, for example, a round number, of the standby node, so that the first node may make a decision based on the round number included in the first indication information, to determine whether the standby node can switch the active-standby state, that is, whether the standby node can upgrade to the active node, to replace the second node. It may be understood that, in embodiments of this application, the round number is a number of a round in which the node participates in election for the active node, and may increase with increase of an election round of the node. If the node does not participate in the election, the round number may remain unchanged. A manner of increasing the round number may be implemented by maintaining a corresponding counting function on a node side. This is not limited in embodiments of this application.

The election manner is an implementation of switching the active-standby state by the standby node, and the round number is also an example of the election information. In actual application, the standby node may alternatively request to switch the active-standby state in another manner or by using other information. This is not limited in embodiments of this application. In an optional implementation, the first node may compare the round number included in the first indication information with a round number of the current active node. If the round number included in the first indication information is greater than the round number of the current active node, the first node determines that the standby node can switch to the active node; or if the round number included in the first indication information is less than or equal to the round number of the current active node, the first node determines that the standby node cannot switch to the active node.

In an optional implementation, the first node may send indication information to the current active node, to indicate the active node to switch the active-standby state and switch from the active node to the standby node. In another optional implementation, the current active node may alternatively receive the first indication information from the standby node, and compare the round number included in the first indication information with a locally stored round number. If the round number included in the first indication information is greater than the locally stored round number, the current active node may actively switch the active-standby state, and switch from the active node to the standby node. Therefore, the first node does not need to indicate the second node to switch the active-standby state, to reduce signaling interaction and reduce overheads.

With reference to the first aspect, in a possible implementation, the first indication information may be included in a broadcast message or a system message from the third node, and the broadcast message or the system message of the third node may further include at least one of the following information of the third node: a device name, a communication address, an identifier of a supported service capability, or service data information that describes the service capability.

According to the foregoing method, for example, the first indication information may be carried in the broadcast message or the system message from the third node. Therefore, the first node and the third node may trigger active-standby state switching by exchanging a few messages, thereby reducing system overheads.

With reference to the first aspect, in a possible implementation, the working mode of the destination node group is the active-active mode, and before the first node performs data transmission with the destination node based on the first communication link, the method may further include:

The first node receives second indication information from at least two nodes in the destination node group, where the at least two nodes include the second node and the third node; and
the first node establishes communication sublinks with the at least two nodes based on the second indication information.

According to the foregoing method, in the active-active mode, the first node may first establish links with the at least two nodes in the destination node group. The first node may perform data transmission with the destination node based on at least one communication link with the at least two nodes. When a communication link is unavailable, another communication link may be used for data transmission between the first node and the destination node. This can effectively avoid service interruption or a loss problem of important data caused by a sudden fault of a routing node between the first node and the destination node or deterioration of service quality of a communication sublink, and improve reliability of the entire communication system.

With reference to the first aspect, in a possible implementation, the second indication information from each of the at least two nodes includes a group identifier of the destination node group and a node identifier of the node. In an optional implementation, the second indication information may be included in a broadcast message or a system message from the node, and the broadcast message or the system message of the node further includes at least one of the following information of the node: a device name, a communication address, an identifier of a supported service capability, or service data information that describes the service capability.

According to the foregoing method, in the active-active mode, each node in the destination node group may add the group identifier of the destination node group, the node identifier of the node, and the like to the second indication information sent to the first node, so that the first node can establish a link with the node in the destination node group based on the second indication information.

With reference to the first aspect, in a possible implementation, the method may further include:

The first node updates communication link information of the first node based on availability of the communication sublink between the first node and the second node and availability of the communication sublink between the first node and the third node.

According to the foregoing method, the first node may maintain communication link information of the first node. The communication link information may record information about a communication sublink associated with the first node, for example, information about communication sublinks between the first node and the at least two nodes in the destination node group. When a communication link is unavailable, the first node may synchronously update the communication link information of the first node, for example, delete link information of the unavailable communication sublink, or add link information of a newly established communication sublink, so that the first node can continue subsequent communication interaction based on updated communication link information.

With reference to the first aspect, in a possible implementation, a first communication technology is used for the communication sublink between the first node and the second node, and the first communication technology is a wired communication technology or a first wireless communication technology. In another possible implementation, a second communication technology is used for the communication sublink between the first node and the third node, and the second communication technology is a second wireless communication technology different from the first wireless communication technology. The first wireless communication technology may be the same as or different from the second wireless communication technology. For example, when being the same, the first wireless communication technology and the second wireless communication technology may be the short-range wireless communication technology specified by SparkLink. This is not limited in embodiments of this application.

According to a second aspect, an embodiment of this application provides a communication method, where the method may be applied to a first node, the first node, for example, corresponds to the third node in embodiments of the first aspect, and the method may include:

The first node determines at least two nodes included in a destination node group to which the first node belongs; and
when a second node of the at least two nodes is unavailable, the first node performs data transmission between a third node and a destination node based on a working mode of the destination node group and a first communication link, where the second node is included in a second communication link that is between the third node and the destination node and that is different from the first communication link, and the at least two nodes in the destination node group are configured to establish a communication connection for the third node and the destination node.

According to the foregoing method, data transmission may be performed between the third node (for example, the first node in embodiments of the first aspect) and the destination node through at least one communication link, for example, the first communication link (for example, the second communication link in embodiments of the first aspect) and the second communication link (for example, the first communication link in embodiments of the first aspect). Nodes included in the at least one communication link may be different. For example, the first communication link includes the first node (for example, the third node in embodiments of the first aspect), and the second communication link includes the second node (for example, the second node in embodiments of the first aspect). The first node and the second node may both belong to the destination node group. When the second node is unavailable, the first node may determine that the second communication link is unavailable. In this case, the first node may perform data transmission between the third node and the destination node based on the first communication link, to ensure service continuity and improve reliability and stability of an entire communication system.

With reference to the second aspect, in a possible implementation, that the first node determines at least two nodes included in a destination node group to which the first node belongs may include:

The first node receives first indication information from at least one node, where the first indication information indicates a group identifier of a node group to which the node belongs; and
the first node determines, based on the first indication information, at least one node that belongs to the destination node group to which the first node belongs.

According to the foregoing method, a relationship between a node and a node group may be preconfigured, and different nodes may perform a device discovery process based on configuration information of the nodes, to determine whether the nodes belong to a same node group. Further, an identity negotiation process may be performed between nodes that belong to the same node group, to negotiate and determine a working mode of the node group and an identity of each node in the node group. When the working mode of the node group and the identity of each node in the node group are determined, different nodes in the node group may establish links with a node (for example, the first node and the destination node) outside the node group based on a requirement and perform data transmission. It should be understood that the group identifier is merely an example of grouping information of the nodes belonging to the same node group in embodiments of this application, and is not any limitation. In another embodiment, node groups to which different nodes belong may be configured by using other information.

With reference to the second aspect, in a possible implementation, the first indication information further indicates a service capability of the node, and the method may further include:

The first node determines the working mode of the destination node group by negotiating with a fourth node in the destination node group based on service capabilities of the at least two nodes included in the destination node group.

According to the foregoing method, a networking manner or a communication manner of each node in the destination node group may be preconfigured, and the first node may flexibly perform identity negotiation with another node in the same group, to determine the working mode. For example, the negotiation manner may include: any node in the destination node group may serve as a discovered party to broadcast the first indication information, or any node may serve as a discovering party to receive the first indication information from another node, where the first indication information may indicate the service capability of the node. Different nodes perform identity negotiation based on the first indication information exchanged between the nodes. A specific implementation of a negotiation process is not limited in embodiments of this application, and specific content included in the exchanged first indication information is not limited. In an optional implementation, the working mode of the node group may also be preconfigured (for example, configured in a service capability attribute of a node). In the destination node group, the first node may exchange preconfigured working mode information in an identity negotiation process with the fourth node, to determine the working mode of the destination node group. For example, when the short-range wireless communication technology specified by SparkLink is used, the identity negotiation process may include, for example, a device discovery and service discovery process.

With reference to the second aspect, in a possible implementation, the method may further include:
when performing data transmission with the destination node based on the first communication link, the first node performs, based on a communication link with the fourth node, data backup on the fourth node for data transmitted based on the first communication link with the destination node.

According to the foregoing method, horizontal data backup may be further performed between different nodes in a same node group, to ensure service continuity.

With reference to the second aspect, in a possible implementation, the method may further include:

The first node stores at least one of the following information of the destination node group to which the first node belongs:
a group identifier, the working mode, management node information, member node information, service capability attribute information of an included node, and communication domain resource information of an included node.

According to the foregoing method, any node in the node group may maintain and record related information of some or all nodes that belong to a same node group as the node, including but not limited to the foregoing examples, to control or manage different nodes in the same node group. It should be understood that the related information of some or all nodes in the same node group may be recorded in an information list maintained by any node in the node group. The list may be referred to as, for example, a neighboring node information table. A manner of recording and a manner of storing the information are not limited in embodiments of this application.

With reference to the second aspect, in a possible implementation, the working mode of the destination node group is an active-standby mode, and the method may further include:

The first node sends second indication information to the third node, where the second indication information is used to request to switch an active-standby state for the first node.

According to the foregoing method, in the active-standby mode, the first node represents a standby node, and the second node represents an active node. For example, when finding that the active node is unavailable, the standby node may actively trigger an active-standby state switching process, so that the standby node may switch to the active node, to replace the original active node to continue to implement a service, thereby ensuring service continuity. For example, the first node may send the second indication information in a broadcast manner, and both the third node and the second node may receive the second indication information through scanning. After receiving the second indication information from the first node, the second node may further perform evaluation based on the second indication information. When determining that the first node can switch from the standby node to the active node, the second node may actively switch from the active node to the standby node. It may be understood that, the active node and the standby node in the destination node group may monitor, for example, by exchanging heartbeat packets, whether the peer node is available. An actual process in which the standby node triggers active-standby state switching is not limited in embodiments of this application.

With reference to the second aspect, in a possible implementation, the second indication information includes the group identifier of the destination node group and a round number of the first node used for active node election. It should be understood that an election manner is merely an example of an implementation of the active-standby state switching process in embodiments of this application, and is not any limitation. In another embodiment, the standby node may switch to the active node in another manner.

With reference to the second aspect, in a possible implementation, the second indication information is included in a broadcast message or a system message of the first node, and the broadcast message or the system message of the first node further includes at least one of the following information of the first node: a device name, a communication address, an identifier of a supported service capability, or service data information that describes the service capability.

With reference to the second aspect, in a possible implementation, the working mode of the destination node group is an active-active mode, and the method may further include: The first node sends third indication information to the third node, where the third indication information is used to request to establish a communication link.

According to the foregoing method, in the active-active mode, the first node may represent any node in the node group, and the first node is a to-be-activated node. The first node may send the third indication information to the third node, to establish a link with the third node, to perform data transmission based on the established communication link. Optionally, the first node may send the third indication information in a broadcast manner, and the third indication information may include at least the group identifier of the destination node group and a node identifier of the first node. Optionally, the third indication information may be included in a broadcast message or a system message of the first node, and the broadcast message or the system message of the first node further includes at least one of the following information of the first node: a device name, a communication address, an identifier of a supported service capability, or service data information that describes the service capability.

With reference to the second aspect, in a possible implementation, a first communication technology is used for a communication sublink between the second node and the third node, and the first communication technology is a wired communication technology or a first wireless communication technology. In another possible implementation, a second communication technology is used for a communication sublink between the first node and the third node, and the second communication technology is a second wireless communication technology different from the first wireless communication technology. The first wireless communication technology may be the same as or different from the second wireless communication technology. For example, when being the same, the first wireless communication technology and the second wireless communication technology may be the short-range wireless communication technology specified by SparkLink. This is not limited in embodiments of this application.

According to a third aspect, an embodiment of this application provides a communication apparatus, applied to a first node. The apparatus includes:
a communication unit, configured to: perform data transmission with a destination node based on a first communication link, where the first communication link includes a second node; and when the first communication link is unavailable, perform data transmission with the destination node based on a second communication link different from the first communication link, where the second communication link includes a third node different from the second node, the second node and the third node belong to a destination node group, and a node included in the destination node group is configured to establish a communication connection for a first node and the destination node.

With reference to the third aspect, in a possible implementation, that the first communication link is unavailable is represented by any one of the following:
the second node is unavailable;
in the first communication link, a communication sublink between the first node and the second node is unavailable; and
in the first communication link, a communication sublink between the second node and the destination node is unavailable.

With reference to the third aspect, in a possible implementation, the second communication link includes the third node, the third node and the second node belong to the destination node group, and a working mode of the destination node group includes any one of the following: an active-standby mode or an active-active mode.

With reference to the third aspect, in a possible implementation, the working mode of the destination node group is the active-standby mode, and the communication unit is further configured to:
receive first indication information from the third node, where the first indication information is used to request to switch an active-standby state for the third node; and
when a processing unit determines to allow the third node to switch from a standby node to an active node, send a connection request message to the third node, where the connection request message is used to request to establish a communication sublink with the third node, and the second communication link includes the communication sublink between the first node and the third node.

With reference to the third aspect, in a possible implementation, the first indication information includes a group identifier of the destination node group and a round number of the third node used for active node election.

With reference to the third aspect, in a possible implementation, the first indication information is included in a broadcast message or a system message from the third node, and the broadcast message or the system message further includes at least one of the following information of the third node: a device name, a communication address, an identifier of a supported service capability, or service data information that describes the service capability.

With reference to the third aspect, in a possible implementation, the working mode of the destination node group is the active-active mode, and before the first node performs data transmission with the destination node based on the first communication link, the communication unit is further configured to:
receive second indication information from at least two nodes in the destination node group, where the at least two nodes include the second node and the third node; and
establish communication sublinks with the at least two nodes based on the second indication information.

With reference to the third aspect, in a possible implementation, the second indication information from each of the at least two nodes includes a group identifier of the destination node group and a node identifier of the node.

With reference to the third aspect, in a possible implementation, the second indication information is included in a broadcast message or a system message from the node, and the broadcast message or the system message of the node further includes at least one of the following information of the node: a device name, a communication address, an identifier of a supported service capability, or service data information that describes the service capability.

With reference to the third aspect, in a possible implementation, the processing unit is further configured to:
update communication link information of the first node based on availability of the communication sublink between the first node and the second node and availability of the communication sublink between the first node and the third node.

With reference to the third aspect, in a possible implementation, a first communication technology is used for the communication sublink between the first node and the second node, and the first communication technology is a wired communication technology or a first wireless communication technology.

With reference to the third aspect, in a possible implementation, a second communication technology is used for the communication sublink between the first node and the third node, and the second communication technology is a second wireless communication technology different from the first wireless communication technology.

According to a fourth aspect, an embodiment of this application provides a communication apparatus, applied to a first node. The apparatus includes:
a determining unit, configured to determine at least two nodes included in a destination node group to which the first node belongs; and
a communication unit, configured to: when a second node of the at least two nodes is unavailable, perform data transmission between a third node and a destination node based on a working mode of the destination node group and a first communication link, where the second node is included in a second communication link that is between the third node and the destination node and that is different from the first communication link, and the at least two nodes in the destination node group are configured to establish a communication connection for the third node and the destination node.

With reference to the fourth aspect, in a possible implementation, the communication unit is configured to receive first indication information from at least one node, where the first indication information indicates a group identifier of a node group to which the node belongs.

The determining unit is configured to determine, based on the first indication information, at least one node that belongs to the destination node group to which the first node belongs.

With reference to the fourth aspect, in a possible implementation, the first indication information further indicates a service capability of the node, and the determining unit is configured to:

The first node determines the working mode of the destination node group by negotiating with a fourth node in the destination node group based on service capabilities of the at least two nodes included in the destination node group.

With reference to the fourth aspect, in a possible implementation, the communication unit is further configured to:
when performing data transmission with the destination node based on the first communication link, perform, based on a communication link with the fourth node, data backup on the fourth node for data transmitted based on the first communication link with the destination node.

With reference to the fourth aspect, in a possible implementation, the apparatus further includes: a storage unit, configured to store at least one of the following information of the destination node group to which the first node belongs:
a group identifier, the working mode, management node information, member node information, service capability attribute information of an included node, and communication domain resource information of an included node.

With reference to the fourth aspect, in a possible implementation, the working mode of the destination node group is an active-standby mode, and the communication unit is further configured to:
send second indication information to the third node, where the second indication information is used to request to switch an active-standby state for the first node.

With reference to the fourth aspect, in a possible implementation, the second indication information includes the group identifier of the destination node group and a round number of the first node used for active node election.

With reference to the fourth aspect, in a possible implementation, the second indication information is included in a broadcast message or a system message of the first node, and the broadcast message or the system message of the first node further includes at least one of the following information of the first node: a device name, a communication address, an identifier of a supported service capability, or service data information that describes the service capability.

With reference to the fourth aspect, in a possible implementation, the working mode of the destination node group is an active-active mode, and the communication unit is further configured to:
send third indication information to the third node, where the third indication information is used to request to establish a communication link.

With reference to the fourth aspect, in a possible implementation, the third indication information includes the group identifier of the destination node group and a node identifier of the first node.

With reference to the fourth aspect, in a possible implementation, the third indication information is included in a broadcast message or a system message of the first node, and the broadcast message or the system message of the first node further includes at least one of the following information of the first node: a device name, a communication address, an identifier of a supported service capability, or service data information that describes the service capability.

With reference to the fourth aspect, in a possible implementation, a first communication technology is used for a communication sublink between the second node and the third node, and the first communication technology is a wired communication technology or a first wireless communication technology.

With reference to the fourth aspect, in a possible implementation, a second communication technology is used for the communication sublink between the first node and the third node, and the second communication technology is a second wireless communication technology different from the first wireless communication technology.

According to a fifth aspect, an embodiment of this application provides a communication system, including a communication apparatus configured to implement the method according to any one of the first aspect and the possible implementations of the first aspect, and a communication apparatus configured to implement the method according to any one of the second aspect and the possible implementations of the second aspect.

For example, the system may include a first node, a second node, a third node, and a destination node, the second node and the third node belong to a destination node group, and a node included in the destination node group is configured to establish a communication connection for the first node and the destination node.

The first node is configured to: perform data transmission with the destination node based on a first communication link, where the first communication link includes the second node; and when the first communication link is unavailable, perform data transmission with the destination node based on a second communication link, where the second communication link includes the third node.

According to a sixth aspect, an embodiment of this application provides a communication apparatus, including at least one processor and an interface circuit, where the interface circuit is configured to provide data or code instructions for the at least one processor, and the at least one processor is configured to implement the method according to any one of the first aspect and the possible implementations of the first aspect or the method according to any one of the second aspect and the possible implementations of the second aspect by using a logic circuit or the code instructions.

According to a seventh aspect, an embodiment of this application provides a computer-readable storage medium, where the computer-readable storage medium stores a computer program, and when the computer program is run on a computer, the computer is enabled to perform the method according to any one of the first aspect and the possible implementations of the first aspect or the method according to any one of the second aspect and the possible implementations of the second aspect.

According to an eighth aspect, an embodiment of this application provides a computer program product. When the computer program product runs on a computer, the computer is enabled to perform the method according to any one of the first aspect and the possible implementations of the first aspect or the method according to any one of the second aspect and the possible implementations of the second aspect.

According to a ninth aspect, an embodiment of this application provides a chip system. The chip system includes a processor, configured to invoke a computer program or computer instructions stored in a memory, so that the processor performs the method according to any one of the first aspect and the possible implementations of the first aspect or the method according to any one of the second aspect and the possible implementations of the second aspect.

With reference to the ninth aspect, in a possible implementation, the processor may be coupled to the memory through an interface.

With reference to the ninth aspect, in a possible implementation, the chip system may further include the memory, and the memory stores the computer program or the computer instructions.

According to a tenth aspect, an embodiment of this application provides a processor. The processor is configured to invoke a computer program or computer instructions stored in a memory, so that the processor performs the method according to any one of the first aspect and the possible implementations of the first aspect or the method according to any one of the second aspect and the possible implementations of the second aspect.

According to an eleventh aspect, an embodiment of this application provides a terminal device. The terminal device may be configured to implement the method according to the first aspect or the possible implementations of the first aspect or the method according to any one of the second aspect and the possible implementations of the second aspect. Examples of some terminal devices include but are not limited to: an intelligent transportation device (for example, a car, a ship, an unmanned aerial vehicle, a train, or a truck), an intelligent manufacturing device (for example, a robot, an industrial device, intelligent logistics, or an intelligent factory), an intelligent terminal (for example, a mobile phone, a computer, a tablet computer, a palmtop computer, a desktop computer, a headset, a speaker, a wearable device, or a vehicle-mounted device), a battery management system, and the like.

According to a twelfth aspect, an embodiment of this application provides a vehicle. The vehicle may be configured to implement the method according to the first aspect and the possible implementations of the first aspect or the method according to any one of the second aspect and the possible implementations of the second aspect. Alternatively, the vehicle may include the apparatus according to the third aspect or the apparatus according to the fourth aspect.

Based on the implementations provided in the foregoing aspects, embodiments of this application may be further combined to provide more implementations.

For technical effect that can be achieved by any possible implementation in any one of the third aspect to the tenth aspect, refer to descriptions of technical effect that can be achieved by any possible implementation in any one of the first aspect or the second aspect. No repeated description is provided.

### BRIEF DESCRIPTION OF DRAWINGS

FIG. 1 is a diagram of an architecture of a communication system according to an example embodiment of this application;

FIG. 2a and FIG. 2b are principle diagrams of a communication solution according to an example embodiment of this application;

FIG. 3 is a diagram of another architecture of a communication system according to an example embodiment of this application;

FIG. 4a, FIG. 4b, and FIG. 4c are principle diagrams of implementing a redundant communication solution in different working modes according to an example embodiment of this application;

FIG. 5 is a diagram of a communication protocol architecture of a communication node that uses a short-range communication technology according to an example embodiment of this application;

FIG. 6 is a diagram of networking of at least two communication nodes by using a short-range communication technology according to an example embodiment of this application;

FIG. 7A and FIG. 7B are a schematic flowchart of a redundant communication method in an active-standby mode according to an example embodiment of this application;

FIG. 8A to FIG. 9B are schematic flowcharts of a redundant communication method in an active-active mode according to an example embodiment of this application;

FIG. 10 is a schematic flowchart of a communication method according to an example embodiment of this application;

FIG. 11 is a schematic flowchart of a communication method according to an example embodiment of this application;

FIG. 12 is a diagram of a structure of a communication apparatus according to an example embodiment of this application;

FIG. 13 is a diagram of a structure of a communication apparatus according to an example embodiment of this application; and

FIG. 14 is a diagram of a structure of a communication apparatus according to an example embodiment of this application.

### DESCRIPTION OF EMBODIMENTS

For ease of understanding the technical solutions in embodiments of this application, the following first explains and describes some related terms.

### 1. Node Group

In a communication system, based on application scenarios, service requirements, and the like, at least two communication nodes in an association relationship may be grouped into a same group, which may be referred to as a node group. The association relationship may be, for example, a service association relationship or a communication association relationship. This is not limited. Nodes belonging to a same node group may be associated with a same information identifier, for example, a group identifier (ID), a service identifier, or a communication identifier. This is not limited.

Any node in the node group may provide communication support for a source node and a destination node that perform data transmission. Alternatively, it may be understood as that the source node and the destination node establish a communication connection through a node in the node group. For example, a communication link is established between the source node and the destination node, where the communication link may include a communication sublink established between a node in the node group and the source node, and a communication sublink established between the node and the destination node. Based on information such as a working mode or a working identity preconfigured for a node in a node group, different nodes in a same node group may establish a primary communication link and a redundant communication link that are used for data transmission between the source node and the destination node. The redundant communication link is a backup link of the primary communication link. When the primary communication link is unavailable, the redundant communication link may still provide communication support for data transmission between the source node and the destination node, to ensure service continuity.

It should be understood that the data source node and the destination node described herein are relative to the node in the node group. The source node represents only a data source node relative to the node in the node group, and the destination node represents only a data destination node relative to the node in the node group. A real data transmission path is not limited. In actual application, another communication node may be further included between a node in the node group and a source node or a destination node.

In embodiments of this application, a communication system may include at least one node group. When the communication method in embodiments of this application is implemented, a node group in the method may be referred to as a destination node group.

In addition, in addition to the node group, the communication system in embodiments of this application may further include communication nodes that are not associated as a group. For details, refer to the following detailed description of the communication system.

### 2: Communication System

In embodiments of this application, a communication system is a general term for technical systems used to complete an information transmission process. Generally, the communication system may include one or more communication nodes of an information source, a sending device, a channel, a receiving device, a trustee, and the like, which jointly complete a task of transferring information from the information source to a trustee node.

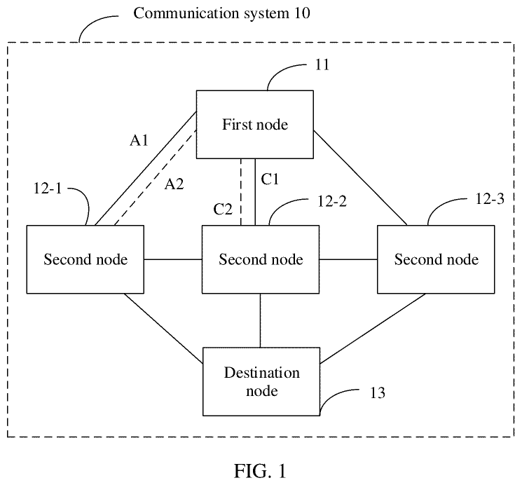

In embodiments of this application, for ease of differentiation, in addition to a destination node (for example, the trustee node), the communication system may include at least two types of communication nodes, which are represented as a first node and a second node. As shown in FIG. 1, a communication system 10 may include a first node 11, at least two second nodes 12 (for example, second nodes 12-1, 12-2, and 12-3), and a destination node 13. The at least two second nodes 12 may be associated as a node group based on respective configuration information, and have a corresponding group identifier or another information identifier.

The first node 11 may be used as a data source node to directly or indirectly perform communication interaction with the at least two second nodes 12. Alternatively, any two of the at least two second nodes 12 may directly or indirectly perform communication interaction with each other. The first node 11 may perform communication interaction with the destination node 13 through any second node 12. Different second nodes that belong to the communication node group may provide at least one communication link between the first node 11 and the destination node 13. The at least one communication link may be used for communication or redundant communication between the first node 11 and the destination node 13, to ensure service continuity.

It should be understood that the communication system 10 may alternatively include at least two first nodes, and may further include another type of communication node. Types, a quantity, or the like of communication nodes are not limited in embodiments of this application. A communication link between any two nodes may also be included in another communication link as a communication sublink. For example, in FIG. 1, when the first node 11 performs communication interaction with the destination node 13 through the second node 12-1, the communication link between the first node 11 and the destination node 13 includes a communication sublink between the first node 11 and the second node 12-1, and a communication sublink between the second node 12-1 and the destination node 13.

In a possible implementation, at least one communication technology, for example, a wired communication technology and a short-range wireless communication technology, including but not limited to a Bluetooth technology, a wireless fidelity (Wi-Fi) technology, a near field communication (NFC) technology, a Wi-Fi aware technology, a universal short-range communication technology, and a short-range wireless communication technology specified by SparkLink may be supported between the first node 11/the destination node 13 and each second node 12. Based on a specifically used communication technology, the communication system 10 may be a homogeneous communication system or a heterogeneous communication system. When the communication system 10 is the heterogeneous communication system, the communication system 10 may also be referred to as a converged communication system, a tight interworking (tight interworking) communication system, or an interworking (interworking) communication system. A communication technology actually used in the communication system is not limited in embodiments of this application.

It should be noted that solid/dashed connection lines between the nodes shown in FIG. 1 only indicate that two communication nodes may establish at least one communication link (for example, at least one communication link between the first node 11 and the second node 12-1 is represented as a communication link A1 or a communication link A2, and at least one communication link between the first node 11 and the second node 12-2 is represented as a communication link C1 or a communication link C2) and perform communication interaction. A specific communication manner is not limited. The solid/dashed connection line is used for distinguishing, and it may be understood that two corresponding communication links are obtained by using two different communication technologies. For example, the communication link A1 is a wired communication link, and the communication link A2 is a short-range wireless communication link. Alternatively, it may be understood that two communication links use a same communication technology but are in different statuses. For example, the communication link C1 is in an activated state (for example, the communication link is established) and is occupied, and the communication link C2 is in the activated state but is not occupied. Different communication between a same first node 11 and different second nodes 12 may also have similar understandings. This is not limited in embodiments of this application.

In embodiments of this application, any one of the first node 11, any second node 12, the destination node, or another communication node that is not shown in the communication system may be an electronic device having data receiving and sending capabilities.

For example, the electronic device may be a terminal device, including a device that provides voice and/or data connectivity for a user, and specifically including a device that provides voice for the user, or including a device that provides data connectivity for the user, or including a device that provides voice and data connectivity for the user. For example, a handheld device with a wireless connection function or a processing device connected to a wireless modem is included. For example, the terminal device may communicate with a core network through a radio access network (RAN), and exchange voice and/or data with the RAN.

In a specific implementation process, the terminal device may include but is not limited to a vehicle, user equipment (UE), a wireless terminal device, a mobile terminal device, a device-to-device (D2D) terminal device, a vehicle-to-everything (V2X) terminal device, a machine-to-machine/machine-type communication (M2M/MTC) terminal device, an internet of things (IoT) terminal device or a narrowband internet of things (NB-IoT) terminal device, a subscriber unit, a subscriber station, a mobile station, a mobile, a remote station, an access point (AP), a remote terminal device, an access terminal device, a user terminal device, a user agent, a user device, or the like. For another example, the terminal device may be specifically implemented as: a mobile phone (or referred to as a “cellular” phone) or a computer having a mobile terminal device; a dedicated IoT terminal device, an industrial control device, a remote medical device, a smart grid device, or a smart city device; a portable, pocket-sized, handheld, computer built-in, or vehicle-mounted mobile apparatus; or a personal communication service (PCS) phone, a cordless phone, a session initiation protocol (SIP) telephone, a wireless local loop (WLL) station, a personal digital assistant (PDA), or the like. In an optional implementation, the terminal device may be further implemented as a restricted device, for example, a device with low power consumption, a device with a limited storage capability, or a device with a limited computing capability. In an optional implementation, the terminal device may include components such as a barcode, a radio frequency identification (RFID), a sensor, a global positioning system (GPS), and a laser scanner.

In an optional implementation, the terminal device may alternatively be a wearable device. The wearable device may also be referred to as a wearable intelligent device, an intelligent wearable device, or the like, and is a general term of wearable devices that are intelligently designed and developed for daily wear by using a wearable technology, for example, glasses, gloves, watches, clothes, and shoes. The wearable device is a portable device that can be directly worn on the body or integrated into clothes or an accessory of a user. The wearable device is not only a hardware device, but also implements a powerful function through software support, data exchange, and cloud interaction. In a broad sense, wearable intelligent devices include full-featured and large-sized devices that can implement all or a part of functions without depending on smartphones, for example, smart watches or smart glasses, and include devices that dedicated to only one type of application function and need to collaboratively work with other devices such as smartphones, for example, various smart bands, smart helmets, or smart jewelry for monitoring physical signs.

In an optional implementation, the terminal device may alternatively be a machine intelligent device like a self-driving device, a transportation safety device, a virtual reality (VR) terminal device, or an augmented reality (AR) terminal device.

If the terminal devices described above are located on a vehicle (for example, placed in the vehicle or installed in the vehicle), the terminal devices may be considered as vehicle-mounted terminal devices. The vehicle-mounted terminal device may include, for example, an on-board unit (OBU), a camera, a mobile data center (MDC), a cockpit domain controller (CDC), a battery control unit (BCU), or a battery monitor unit (BMU).

In an optional implementation, the terminal device may further include a relay (relay). Alternatively, it is understood that the terminal device may include any device that can perform data communication with a base station.

For example, the electronic device may alternatively be a network device, for example, include an access network (AN) device. The access network device may include a device, for example, a base station or an access point, that communicates with a wireless terminal device over an air interface in an access network by using one or more cells. The base station may be configured to: perform conversion between a received over-the-air frame and an Internet Protocol (IP) packet, and serve as a router between the terminal device and other parts of the access network, where the other parts of the access network may include an IP network. In an optional implementation, the network device may include a base station in a 2nd generation (2G) communication system, or include a base station in a 3rd generation (3G) communication system, or include a base station in a 4th generation (4G) communication system, for example, an evolved NodeB (NodeB, eNB, or e-NodeB, evolved NodeB) in a long term evolution (LTE) system or a long term evolution-advanced (LTE-A) system, or may include a next-generation NodeB (gNB) in a 5th generation (5G) new radio (NR) system (also referred to as an NR system), or may include a central unit (CU) and a distributed unit (DU) in a cloud radio access network (cloud RAN) system, and a base station in various future communication systems, for example, a base station in a 6th generation (6G) communication system. This is not limited in embodiments of this application. For another example, the network device may include a network device in V2X, that is, a road side unit (RSU). The RSU may include a fixed infrastructure entity supporting a V2X application, and may exchange a message with another entity supporting the V2X application. For another example, the network device may further include a core network device. The core network device includes, for example, one or more of the following in a 5G system: an access and mobility management function (AMF), a session management function (SMF), and a user plane function (UPF), or includes a mobility management entity (MME) in a 4G system.

It should be understood that, in some technical scenarios, an electronic device with similar data receiving and sending capabilities may not be referred to as a node. However, for ease of description, electronic devices with the data receiving and sending capabilities are collectively referred to as nodes in embodiments of this application. In different used communication technologies, a node may also have a specific name. For example, when a short-range wireless communication technology specified by SparkLink is used, the first node described in embodiments of this application may be referred to as a T node, and the second node may be referred to as a G node.

It should be noted that a system architecture shown in FIG. 1 does not constitute a limitation on a system architecture to which embodiments of this application are applicable. A quantity of communication nodes in the figure is merely an example. In actual application, the network device may provide services for a plurality of terminal devices, and the network device and all or some of the plurality of terminal devices may use the communication method provided in embodiments of this application. Each function or device in embodiments of this application may also be referred to as a communication apparatus, and the communication apparatus may be a general-purpose device or a dedicated device. This is not specifically limited in embodiments of this application.

It should be noted that in embodiments of this application, a term “at least one” means one or more, and “a plurality of” means two or more. “And/or” describes an association relationship between associated objects, and represents that at least three relationships may exist. For example, A and/or B may represent the following cases: A exists alone, both A and B exist, and B exists alone, where A and B may be singular or plural. A character “/” usually indicates an “or” relationship between the associated objects. “At least one of the following items (pieces)” or a similar expression thereof refers to any combination of these items, including any combination of singular items (pieces) or plural items (pieces). For example, at least one item (piece) of a, b, or c may indicate: a, b, c, a and b, a and c, b and c, or a, b, and c, where a, b, and c may be singular or plural.

Unless otherwise specified, ordinal numbers such as “first”, “second”, and “third” mentioned in embodiments of this application are used to distinguish a plurality of objects, but are not used to limit priorities or importance degrees of the plurality of objects. For example, the first node, the second node, and the third node are merely used to distinguish different nodes, but do not indicate different priorities, importance degrees, or the like of the three nodes.

### 3. Redundant Communication

In communication engineering, “redundancy” refers to a repeated configuration of some key components or functions for security and reliability of a communication system. When a fault occurs in the communication system, for example, a device is damaged, shut down, or hibernated, a redundant component can be used as a backup to take over work of the faulty component in a timely manner, to shorten fault time of the communication system. Generally, redundancy is used for emergency handling, and may exist at different layers, for example, network (for example, a communication network) redundancy, server redundancy, disk redundancy, and data redundancy.

The redundant communication in embodiments of this application refers to transmission of to-be-transmitted information through a redundant communication link between two or more communication nodes in the communication system, so that when a primary communication link for the to-be-transmitted information is unavailable, the redundant communication link of the communication link continues to complete transmission of the to-be-transmitted information, to ensure continuity of information transmission and improve reliability of the communication system. The to-be-transmitted information described in embodiments of this application may be understood as service data of the communication system, or may be understood as control signaling of the communication system. In an example of service data described in the following embodiments, the service data may be replaced with the control signaling. The redundant communication link in embodiments of this application may include a backup link that is not established and that does not perform data transmission when the primary communication link works, or may include a backup link that performs redundant transmission on the to-be-transmitted information when the primary communication link works. A specific implementation of the to-be-transmitted information or the redundant communication link is not limited in embodiments of this application. In at least one of the following redundant communication manners, when the primary communication link works, a working mechanism of the redundant communication link of the primary communication link is not limited.

In embodiments of this application, for a purpose of the redundant communication, and based on communication technologies used by a communication node and a peer communication node of the communication node, a corresponding redundant communication link may exist or can be established between the first node 11 and each second node 12 in FIG. 1 for redundant communication. Therefore, the following redundant communication manners may be defined in embodiments of this application:

### (1) Manner 1

When two (or more) communication links established by using different communication technologies may exist or can be established between the first node 11 and one second node 12, and one or more communication links may be used as redundant communication links of other communication links.

For example, as shown in FIG. 1, there may be two communication links obtained by using different communication technologies between the first node 11 and the second node 12-1, which are represented as a communication link A1 and a communication link A2. The communication link A1 may be, for example, a wired communication link, and the communication link A2 may be, for example, a short-range wireless communication link. The communication link A2 may be used as a redundant communication link of the wired communication link A1.

The second node 12-1 may activate a redundancy communication capability, and establish the communication link A2 between the second node 12-1 and the first node 11. In one aspect, the communication link A2 and the communication link A1 may work simultaneously. During working of the communication link A2 and the communication link A1, when the first node 11 performs data transmission with the destination node 13 through the wired communication link A1 between the first node 11 and the second node 12-1, the first node 11 performs redundant data transmission with the destination node 13 through the communication link A2 between the first node 11 and the second node 12-1. When the communication link A1 is disconnected or quality of the communication link A1 deteriorates to be lower than a set threshold, the first node 11 may still maintain the communication link A2 with the second node 12-1, and perform data transmission with the destination node 13 based on the communication link A2, to ensure service continuity. In another aspect, the communication link A2 is used as a secondary link of the communication link A1, and may be established or used in real time when the communication link A1 is unavailable. The first node 11 may perform data transmission with the destination node 13 based on the communication link A2.

### (2) Manner 2

The first node 11 may separately establish different communication links with different second nodes 12 by using a same communication technology. A communication link between the first node 11 and one second node 12 may be used as a redundant communication link of a communication link between the first node 11 and another second node 12.

For example, as shown in FIG. 1, the second node 12-1 and the second node 12-2 may be associated as a node group. The second node 12-1 and the second node 12-2 may activate a redundancy communication capability, and the first node 11 may establish the communication link A2 with the second node 12-1, and may establish the communication link C2 with the second node 12-2. In one aspect, the communication link A2 and the communication link C2 may work simultaneously, and the first node 11 may perform data transmission with the destination node 13 based on the communication link A2, and perform redundant data transmission with the destination node 13 based on the communication link C2 simultaneously. After a fault occurs in the second node 12-1, the first node may still maintain the communication link C2 with the second node 12-2, and continue to perform data transmission with the destination node 13 based on the communication link C2. In another aspect, the communication link C2 is used as a secondary link of the communication link A2, and may be established or used when the communication link A2 is unavailable. The first node 11 may perform data transmission with the destination node 13 based on the communication link C2.

### (3) Manner 3

Manner 3 is a combination of the foregoing manner 1 and manner 2.

Two communication links established by using at least one communication technology may exist or can be established between the first node 11 and one second node 12. In addition, the first node 11 may establish different communication links with another second node 12 by using a same communication technology. The two communication links established by the first node 11 with one second node are mutually redundant communication links, and the communication link between the first node 11 and one second node 12 may be used as the redundant communication link of the communication link between the first node 11 and the another second node 12.

For example, as shown in FIG. 1, the second node 12-1 and the second node 12-2 may be associated as a node group. There is the communication link A1 between the first node 11 and the second node 12-1, for example, a wired communication link. In addition, both the second node 12-1 and the second node 12-2 may activate the redundant communication capability. For example, the first node 11 may establish the communication link A2 and the communication link C2 with the second node 12-1 and the second node 12-2 respectively by using a short-range wireless communication technology. The communication link A2 and the communication link C2 may be used as redundant communication links of the communication link A1, and the communication link C2 may also be used as the redundant communication link of the communication link A2. In other words, data transmission or redundant transmission may be performed between the first node 11 and the destination node 13 based on the communication link A1, the communication link A2, and the communication link C2.

In an optional implementation, when the communication link A1 is disconnected or service quality deteriorates to be lower than a set threshold, the first node 11 may still continue to maintain the communication link A2 and the communication link C2, and continue to perform data transmission and redundant transmission, to ensure that a service is not interrupted. When the communication link A2 is disconnected or service quality deteriorates to be lower than a set threshold, the first node 11 may still perform data transmission or redundant transmission based on the communication link A1 and the communication link C2, to ensure that a service is not interrupted. When the second node 12-1 is unavailable due to a fault, hibernation, shutdown, or the like, the first node 11 may still continue to maintain the communication link C2 and continue to perform data transmission, to ensure that the service is not interrupted. Similar to the foregoing manner 1 and manner 2, in manner 3, the communication link A2 or the communication link C2 that is used as the redundant communication link may work simultaneously with a corresponding primary communication link, or may be established or used when the primary communication link is unavailable.

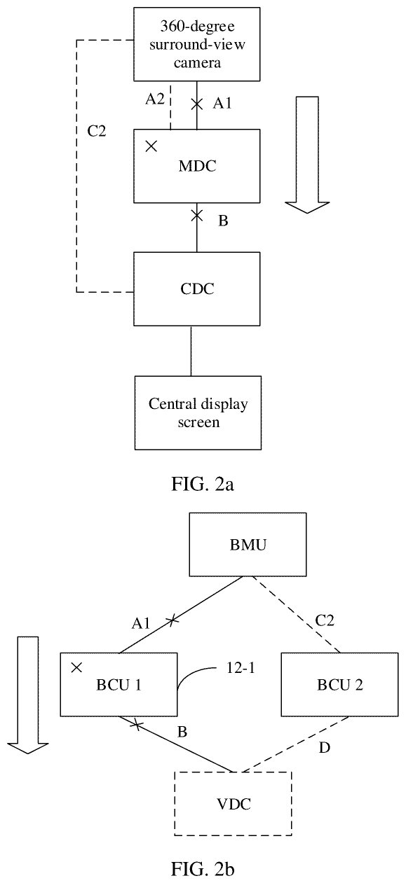

Based on the foregoing three redundant communication manners, when the redundant communication solution in embodiments of this application is implemented between some nodes in the communication system shown in FIG. 1, service data and an architecture of an intelligent vehicle digital platform system are used as an example. As shown in FIG. 2a, the first node 11 in FIG. 1 may be implemented as a 360-degree surround-view camera of a vehicle, and is a source node of data, the second node 12-1 may be, for example, the MDC, the second node 12-2 may be, for example, the CDC, and the destination node 13 may be, for example, a central display screen of the vehicle, and is configured to display an environmental image captured by the 360-degree surround-view camera of the vehicle.

A primary transmission path (for example, referred to as a first communication link) of the data in an arrow direction may be as follows:
360-degree surround-view camera→communication link A1→MDC→communication link B→CDC→central display screen.

A cross sign “x” represents a problem occurrence point of unavailability. The problem occurrence point of unavailability may be located on at least one of the MDC (for example, the MDC is suddenly faulty, sleep, or shut down), the communication link A1, or the communication link B (for example, service interruption or loss of important service data caused by deterioration of service quality of a communication link due to interference). Regardless of where the problem occurrence point is located, service data transmission and service implementation are affected.

Therefore, to ensure service continuity, in embodiments of this application, the communication link C2 that already exists or can be established between the 360-degree surround-view camera and the CDC may be used as a redundant communication link, and a redundant transmission path (for example, referred to as a second communication link) of the data may be as follows:

360-degree surround-view camera→communication link C2→CDC→central display screen. It should be understood that, if the problem occurrence point of unavailability is located only on the communication link A1, the second communication link may be as follows: 360-degree surround-view camera→communication link A2→MDC→communication link B→CDC→central display screen.

Therefore, during working, data collected by the 360-degree surround-view camera can be transmitted to the central display screen based on the redundant communication link C2. When the first communication link is unavailable, the first node 11 can still ensure service continuity based on the data transmitted based on the second communication link with the destination node 13. This improves reliability of an entire communication system.

Similarly, as shown in FIG. 2b, the first node 11 in FIG. 1 is a source node of data, and may be implemented as a BMU, the second node 12-1 may be implemented as a BCU 1, the second node 12-2 may be implemented as a BCU 2, and the destination node 13 may be implemented as a VDC.

A transmission path (for example, referred to as a first communication link) of the data in an arrow direction may be as follows:
BMU→communication link A1→BCU 1→communication link B→VDC.

A redundant transmission path (for example, referred to as a second communication link) of the data may be as follows:
BMU→communication link C2→BCU 2→communication link D→VDC.

Therefore, when a problem occurrence point of unavailability is located on the BCU 1, the communication link A1, or the communication link B, and data transmission between the BMU and the VDC is affected, service continuity can still be ensured for data that is redundantly transmitted between the BMU and the VDC through the path: communication link C2→BCU 2→communication link D. This improves reliability of the entire communication system.

It should be noted that, in FIG. 2a or FIG. 2b, a solid connection line only schematically represents a primary communication link, and is used to transmit service data or control signaling to a destination node; and a dashed connection line only schematically represents a redundant communication link, and is used to replace a corresponding primary communication link to transmit service data or control signaling when an unavailability problem occurs in a communication system. An actual routing path of data or signaling is not limited, and a specific communication manner used by a communication link is not limited either. In some embodiments, a communication link corresponding to a connection line shown in FIG. 2a or FIG. 2b may be an optional communication link for data, and the communication system may further include another communication node and communication link that are not shown.

In embodiments of this application, based on an actually used networking policy and a communication technology, a redundant communication link for data may be pre-owned or established by a communication system, or may be established in real time as required when an unavailability problem occurs in the communication system. An occasion for establishing the redundant communication link is not limited in embodiments of this application. Based on a specific structure of the communication system, any case in which normal transmission of data that passes through the second node is affected because the second node is unavailable or a communication link associated with the second node is unavailable may be understood as that the communication link associated with the second node is unavailable. Correspondingly, in this case, according to the communication method in embodiments of this application, the data transmission link may be switched to a corresponding redundant communication link, to ensure service continuity of the communication system.

It may be understood that FIG. 1, FIG. 2a, and FIG. 2b are examples for describing the communication system in embodiments of this application, and do not constitute any limitation. The communication system in embodiments of this application may include but is not limited to one first node or one destination node.

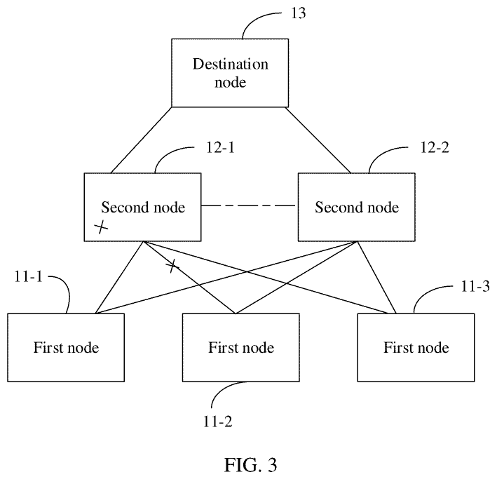

As shown in FIG. 3, for first nodes 11 and second nodes 12 included in the communication system, the communication system may include, for example, three first nodes and two second nodes, which are represented as a first node 11-1, a first node 11-2, and a first node 11-3, and a second node 12-1 and a second node 12-2. The second node 12-1 and the second node 12-2 may be associated as a node group, and have a same group identifier. The first node 11-1, the first node 11-2, and the first node 11-3 may separately establish a primary communication link and a redundant communication link with the second node 12-1 and the second node 12-2 based on an application scenario or a service requirement, to perform data transmission.

### 4. Working Mode

The communication system described above in embodiments of this application may be abstracted as a redundant communication networking architecture (a networking process is described in detail in the following embodiments), and includes a destination node, at least one first node, and at least two second nodes that belong to a same node group, as shown in FIG. 3.

The node group may include two working modes: an active-standby mode and an active-active mode.

The at least two second nodes associated as the same node group may determine a working mode of a destination node group through negotiation. The first node may discover, in a device discovery phase, all second nodes associated as the same node group. Based on the working mode of the node group, operations such as establishing, releasing, reconfiguring, or switching communication links between the first node and the at least two second nodes of the node group may be implemented based on a used destination communication technology.

### (1) Active-Standby Mode

The active-standby mode refers to that at least two second nodes associated as a same group are classified into an active node and a standby node based on roles in a networking architecture.

For example, information such as a group identifier, a working mode, and a working identity of any second node may be preconfigured. Initially, a plurality of second nodes, as discovered parties, may disclose identity information of the plurality of second nodes by using broadcast messages or system messages, including but not limited to device names, communication addresses, identifiers of supported service capabilities, or service data information (for example, including group identifiers and working identities) that describes the service capabilities.

As a discovering party, a first node may receive the broadcast messages or the system messages from the plurality of second nodes, and select an interested device according to a preset screening policy. For example, the first node may determine, based on the group identifiers, at least two second nodes that belong to a same node group, and determine, based on the working identities, an active node and a standby node that are in the same node group.

After the active node is discovered, the first node may establish a communication link with the active node by using a destination communication technology, and perform data transmission with the destination node based on the established communication link, and the first node does not establish a communication link with the standby node. The active node and the standby node in the same group may transmit active-standby heartbeat packets to maintain an active-standby relationship.

When the active node is unavailable due to a fault, hibernation, shutdown, or the like, the standby node may detect, based on the heartbeat packet, that the active node is unavailable, and then the standby node may switch an active-standby state, so that the standby node switches to the active node.

The first node may establish a communication link with the new active node (the original standby node), and release the communication link with the original active node, to complete active-standby state switching. Further, data transmission may continue to be performed between the first node and the new active node based on the established communication link.

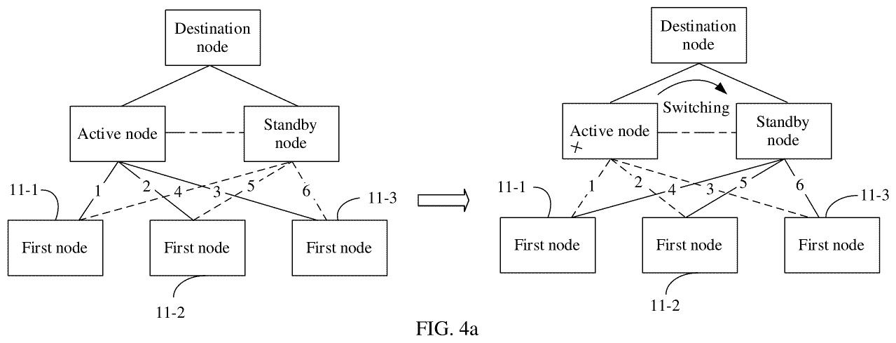

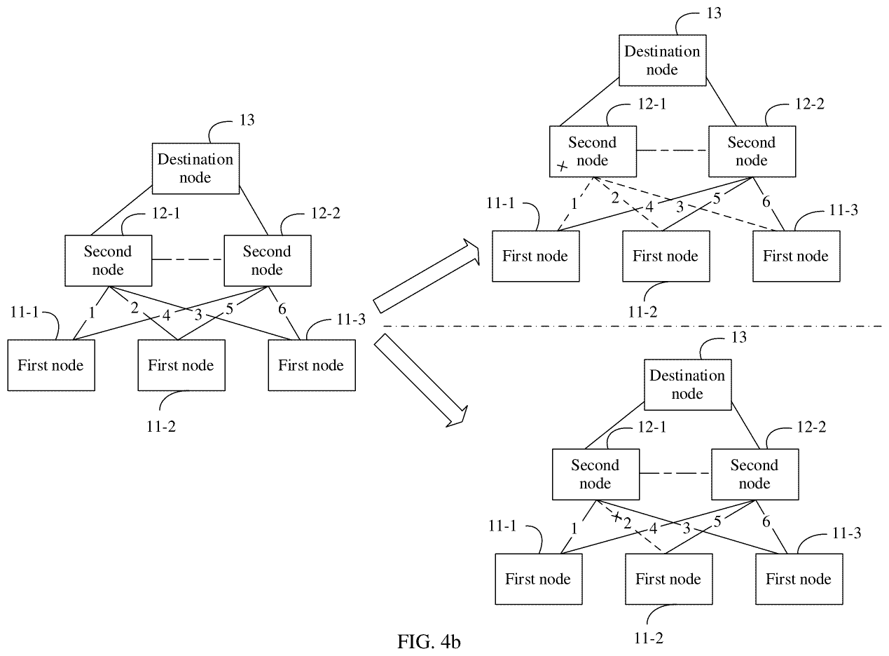

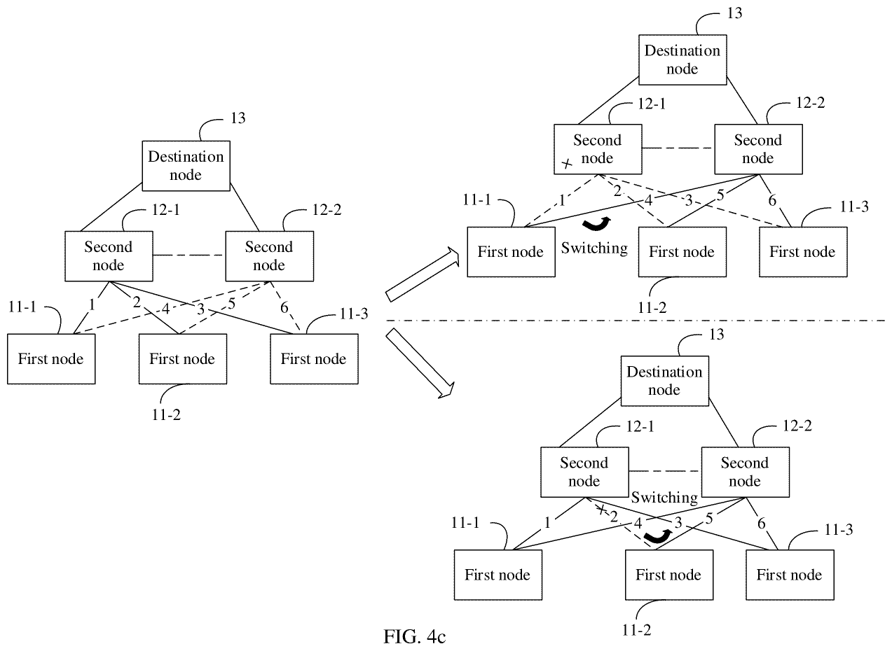

A networking architecture shown in FIG. 3 is used as an example. The second node 12-1 may be used as the active node, and the second node 12-2 may be used as the standby node. As shown on the left side of FIG. 4a, initially, the first node 11-1, the first node 11-2, and the first node 11-3 may separately establish communication links 1, 2, and 3 with the active node, and do not establish communication links 4, 5, and 6 with the standby node. As shown on the right side of FIG. 4a, when the active node is unavailable, the active node and the standby node switch active-standby states, the original standby node switches to a new active node, and the original active node switches to a new standby node. The first node 11-1, the first node 11-2, and the first node 11-3 separately establish communication links 4, 5, and 6 with the new active node (that is, the original standby node), and release the communication links 1, 2, and 3 with the original active node. Further, the first node 11-1, the first node 11-2, and the first node 11-3 separately perform data transmission with the destination node based on the communication links 4, 5, and 6, to ensure service continuity.

It should be noted that, in this embodiment of this application, pre-configuring the working identity for the second node is merely an example of a redundant communication networking architecture in this embodiment of this application, but is not any limitation. In another embodiment, the working modes of the at least two second nodes that belong to the same node group may be preconfigured. The at least two second nodes may also use an election manner, and carry, in broadcast messages or system messages of the at least two second nodes, round numbers used for electing an active node identity, so that the first node serving as the discovering party determines an active node or a standby node of the current round based on received round numbers. A manner of determining an active node and a standby node in a same node group is not limited in embodiments of this application. In an optional implementation, when switching of the active-standby state is involved, the standby node may alternatively add indication information to the broadcast message or the system message of the standby node. The indication information may include the round number used by the standby node to elect the active node. The first node or the active node formulates an active-standby state switching policy for the standby node or the first node or the active node based on received round number, and controls switching of the active-standby state.

### (2) Active-Active Mode

The active-active mode means that at least two second nodes associated as a same group have no role difference in a networking architecture, and a first node may establish a communication link with all second nodes in the same group by using a destination communication technology. When working, the first node may perform data transmission with a destination node based on at least one established communication link.

For example, information such as a group identifier, a working mode, and a working identity of any second node may be preconfigured. Based on the at least one communication link used for actual data transmission, the active-active mode may include specific implementations of the following two aspects:

(2-1): The first node may perform redundant data transmission on communication links established with all second nodes in the node group, that is, one-to-many data transmission. When a second node is unavailable, or a communication link between the second node and the first node is disconnected or service quality deteriorates, a remaining communication link may continue to perform data transmission.

The networking architecture shown in FIG. 3 is still used as an example, in the active-active mode, both the second node 12-1 and the second node 12-2 establish communication links with the first node 11-1, the first node 11-2, and the first node 11-3, which are represented as communication links 1, 2, 3, 4, 5, and 6. During normal working, all communication links 1 to 6 are occupied. As shown on the left side of FIG. 4b, the communication links 4, 5, and 6 are respectively used to perform redundant transmission on data transmitted based on the communication links 1, 2, and 3.

As shown on the upper right side of FIG. 4b, when the second node 12-1 is unavailable, the first node 11-1, the first node 11-2, and the first node 11-3 continue to perform data transmission with the destination node 13 based on the communication links 4, 5, and 6, and release the communication links 1, 2, and 3. As shown on the lower right side of FIG. 4b, when a communication link is unavailable, for example, when the communication link 2 between the second node 12-1 and the first node 11-2 is unavailable, data transmission continues to be performed based on a redundant communication link of the unavailable communication link, and other communication links remain unchanged. For example, the communication link 5 is used as a redundant communication link of the communication link 2 to continue data transmission, and services based on the communication links 1, 3, 4, 5, and 6 are not interrupted.

(2-2): The first node may flexibly select a communication link from communication links established with all activated second nodes in the group to perform data transmission, to implement load sharing. For example, one communication link is randomly selected, or a communication link with optimal quality is selected based on a quality of service (QOS) value of the communication link, and another communication link that is not selected is used as a redundant communication link of the selected communication link. When the selected communication link works normally, another redundant communication link that is not selected is idle.

When the selected communication link is disconnected or service quality deteriorates, or the second node corresponding to the communication link is unavailable, the first node may quickly switch to the redundant communication link of the communication link to continue data transmission, to ensure that a service is not interrupted.

The networking architecture shown in FIG. 3 is still used as an example, in the active-active mode, both the second node 12-1 and the second node 12-2 establish the communication links with the first node 11-1, the first node 11-2, and the first node 11-3, which are represented as the communication links 1, 2, 3, 4, 5, and 6. The first node 11-1, the first node 11-2, and the first node 11-3 all select communication links with the second node 12-1 for data transmission. During normal working, the communication links 4, 5, and 6 between the first node 11-1, the first node 11-2, and the first node 11-3 and the second node 12-2 are idle, as shown on the left side of FIG. 4c.

As shown on the upper right side of FIG. 4c, when the second node 12-1 is unavailable, the first node 11-1, the first node 11-2, and the first node 11-3 quickly switch to the communication links 4, 5, and 6 with the second node 12-2, to continue data transmission, ensure that the service is not interrupted, and release the communication links 1, 2, and 3. As shown in the lower right side of FIG. 4c, when the communication link 2 between the second node 12-1 and the first node 11-2 is disconnected or service quality deteriorates to be lower than a set threshold, the first node 11-2 quickly switches to the communication link 5 to continue data transmission, and services based on the communication links 1, 3, 4, 5, and 6 are not interrupted.

### 5. Redundant Communication Networking Architecture

In embodiments of this application, the redundant communication networking architecture may include a source node, a destination node, and at least one node group. One node group may be formed by associating at least two second nodes in the communication systems shown in FIG. 1, FIG. 2a, FIG. 2b, and FIG. 3. The at least two second nodes may be configured to implement redundant communication with another communication node (for example, the source node or the destination node) in a system.

For example, in FIG. 1, the second node 12-1 and the second node 12-2 may be associated as one node group, the second node 12-2 and the second node 12-3 may be associated as one node group, and the second node 12-1, the second node 12-2, and the second node 12-3 may be associated as one node group. The first node 11 may establish communication links with at least two second nodes in a same node group, and redundantly transmit service data. For another example, in FIG. 2a, FIG. 2b, and FIG. 3, the second node 12-1 and the second node 12-2 may be associated as one node group.

In embodiments of this application, a relationship between a node and a node group may be preconfigured. Different communication nodes that can be associated as a same group may have same information, for example, a service identifier, indicating that the group of communication nodes are configured to implement a service in association, location information, indicating that the group of communication nodes belong to a same location range, and a group identifier. Each node can discover other nodes by using a device discovery mechanism and associate the nodes as a group.

The following describes a redundant communication networking architecture in a SparkLink communication system by using a short-range wireless communication technology specified by SparkLink, a plurality of G nodes (for example, the second nodes in FIG. 1, FIG. 2a, FIG. 2b, and FIG. 3), and a plurality of T nodes (for example, the first node 11 in FIG. 1, FIG. 2a, FIG. 2b, and FIG. 3) as an example.

The plurality of G nodes may determine identities of an advanced G node and a general G node in a SparkLink access layer by using a multi-domain coordination mechanism, and the advanced G node generally loads system air interface resource scheduling. In embodiments of this application, for a networking scenario used for a redundant communication service, information such as a group identifier, a working mode, or a working identity may be preconfigured for each G node based on an application scenario or a service requirement. During networking, the multi-domain coordination mechanism may be extended based on the standard short-range wireless communication protocol specified by SparkLink, and the redundant communication networking mechanism and a universally unique identifier (UUID) that defines a redundant communication service may be extended. The plurality of G nodes disclose identity information of the plurality of G nodes by using broadcast messages or system messages, and negotiate with each other to determine a working mode (for example, an active-standby mode or an active-active mode) of a node group to which the G nodes belong and a working identity of each G node in a corresponding working mode, for example, an active node, a standby node, or an active_G node. The plurality of G nodes are associated as a node group, which is represented as a G-group and has a G-group ID. After discovering the G nodes included in the G-group by using the device discovery mechanism, the plurality of T nodes may establish communication links with some or all nodes in the G-group based on the working mode of the G-group and configuration information of the G nodes included in the G-group, to complete networking. After the networking is completed, when a communication system works, the communication method in embodiments of this application can be implemented, to ensure reliability of the communication system. Optionally, horizontal data backup may be further performed on data transmitted between the nodes included in the G-group, to ensure service continuity.

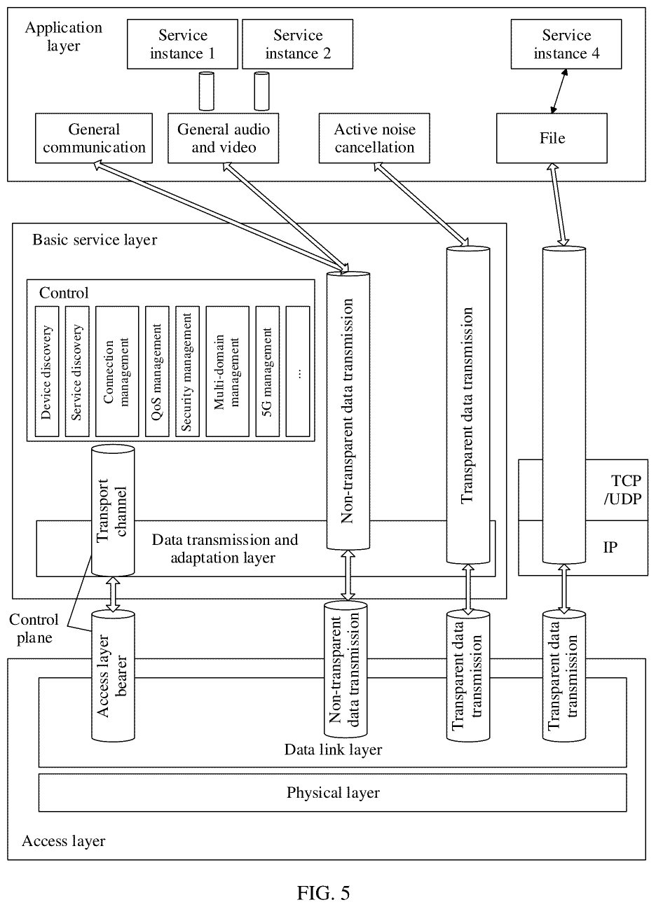

As shown in FIG. 5, in the short-range wireless communication technology specified by SparkLink, a communication protocol architecture of any G node or T node may include an application layer, a basic service layer, and an access layer, and each layer may be referred to as a protocol layer.

It should be understood that the layers herein are merely framework-based structural division, and are generally divided into three large layers: an upper layer, a middle layer, and a bottom layer. Different communication systems may have respective layer division manners, or may have more specific and lower layer division. This is not specifically limited herein. For example, in the conventional technology, there are a plurality of possible network models that have seven layers, five layers, three layers, and the like. A function of each layer may be implemented by using one or more protocols. For example, a protocol of the service layer may include IPv4.

The application layer is located above the basic service layer, and several applications/service instances may be deployed, and may be used to provide a service for the application (also referred to as an application program or a user), for example, a general communication service, a general audio and video service, an active noise cancellation service, and a file service. Optionally, the application layer may be further used to provide session support and/or information support for the user.

The basic service layer is located above the access layer, and is used to establish a connection between a source node (for example, a first node) and a destination node (for example, a second node), and provide an end-to-end information transmission service. Optionally, the basic service layer may further correspond to a network layer or a data transmission and adaptation layer. The network layer may be responsible for performing transmission control and route selection, and determining transmission bearers (or referred to as transport channels) for different functions (for example, device discovery, service discovery, connection management, QoS management, security management, multi-domain management, measurement management, and 5G convergence). Optionally, the network layer may further perform traffic control. The data transmission and adaptation layer may be used to encode or decode data (including transparently transmitted data and non-transparently transmitted data) transmitted by an upper layer, to convert the data into a format compatible with or suitable for transmission.

The access layer may provide a communication interface/mean for communication between nodes. The access layer may include a plurality of different access technologies, and different access technologies may correspond to different communication interfaces, for example, a cellular interface and a Wi-Fi interface. Optionally, the access layer corresponds to a data link layer and a physical layer.

The data link layer ensures reliable data transmission on a physical link. Data or instructions is/are encapsulated into a specific frame that can be transmitted at the physical layer. Optionally, the data link layer further includes functions such as access control, resource management, data segmentation, cascading, and error correction. The data link layer may include one or more access layer bearers (or referred to as link channels or logical channels), used to transmit data or instructions from an upper layer (for example, the service layer).

The physical layer provides a physical connection for the data link layer by using a transmission medium to transparently transmit a bit stream. Generally, channel encoding or decoding is performed at the physical layer, to ensure reliability of data transmission.

Because the service layer may have different networks and/or transmission protocols, the data link layer may be further used to provide a transmission adaptation function with the different networks and/or transmission protocols. For example, a data packet from a bottom layer (a protocol layer below the data link layer) is received, an upper layer (a protocol layer above the data link layer) protocol type to which the data packet belongs is distinguished, and the data packet is delivered (or referred to as transferred) to a corresponding upper layer protocol for processing. It should be noted that the data link layer is a logical function layer, and in implementation, the data link layer may also be included in the service layer. This is not limited in embodiments of this application.

It should be understood that the upper layer of the protocol layer in this application is any protocol layer above the protocol layer, for example, the upper layer of the data link layer, and may include the service layer or the application layer. A process in which an upper layer transmits a data packet to a lower layer may be referred to as transfer. A process in which a lower layer transmits a packet to an upper layer may be referred to as submission.

An implementation process of the communication method in embodiments of this application may mainly include the following three phases.

(1) G-group working mode and identity negotiation phase.

### (1-1): Multi-Domain Device Discovery Phase:

In this phase, any G node may serve as a discovered party and a discovering party, and discover another G node. The G node and the discovered G node may be automatically associated as a node group. The node included in the node group may be, for example, configured to establish a communication connection between a source node (for example, the T node) that executes a service and a destination node.

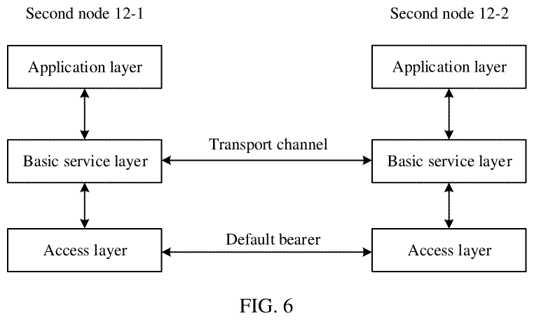

The G node serving as the discovered party may indicate a multi-domain capability of the G node by using an access layer broadcast link, a broadcast group identifier, a media access control (MAC) layer identifier, a UUID (UUID=TBD) of a multi-domain coordination and management service (for example, a redundant communication service, a video service, and an image service), and the like. The G node serving as the discovering party may periodically trigger a multi-domain G device discovery process (for example, at each predetermined scan period duration), or use an event to trigger a multi-domain G device discovery process, to complete multi-domain device discovery. After the multi-domain G device discovery is completed successfully, default bearers may be established between access layers of G nodes that belong to a same node group, and basic server layers establish transport channels for service management. As shown in FIG. 6, a default bearer is established between an access layer of a second node 12-1 and an access layer of a second node 12-2, to transmit control plane signaling, and a transport channel for service management is established between basic service layers, to transmit service data. For related implementation details, refer to a related protocol of a short-range wireless communication technology specified by SparkLink.

### (1-2) Multi-Domain Service Discovery Phase:

After the default bearer is established between the access layers of the G nodes, and the transport channel for service management is established between the basic service layers, a multi-domain service discovery process may be performed. Based on the multi-domain service discovery process, G nodes belonging to a same node group may obtain a multi-domain attribute of another node in the same group, confirm a management mode, confirm a multi-domain service capability and a working mode of the node group, and confirm a G-group association relationship.

Then, each G node belonging to the same node group may determine a multi-domain management node and a member node, and the management node may directly configure a communication domain resource of the member node. Any G node may store a neighboring node information table, and the neighboring node information table may include, for example, but is not limited to, at least one of the following information of the node group to which the G node belongs: a group identifier, the working mode, management node information, member node information, service capability attribute information of an included node, communication domain resource information of an included node, and the like. For related implementation details, refer to a related protocol of a short-range wireless communication technology specified by SparkLink.

(2) G-T device discovery phase.

As a discovered party, any G node in a G-group may disclose information of the G node by carrying indication information in a broadcast message or a system message. The broadcast message or the system message includes, for example, but is not limited to, the following information: a device name, a communication address (for example, a communication domain name and a media access control layer identifier), an identifier list of service capabilities supported by the device (including an extended UUID defining a redundant communication service), and corresponding service data information that describes the service capabilities.

Content of the service data information that describes the redundant communication service may be different in different working modes. For example, in an active-standby mode, service data information that is of each G node and that is used to describe the redundant communication service may include at least a group identifier of a node group to which the G node belongs, a working identity of the G node, and the like. If the G node elects an active node in an election manner, the working identity may be replaced with a round number that is of the G node and that is currently used for active node election. In an active-active mode, the service data information that is of each G node and that is used to describe the redundant communication service may include at least the group identifier of the node group to which the G node belongs and a node identifier of the G node. It should be understood that a frame format of the broadcast message or the system message of the G node is not limited in embodiments of this application, and the UUID used to describe the redundant communication service and the service data information may be carried in a field location specified in a protocol. For related implementation details, refer to a related protocol of a short-range wireless communication technology specified by SparkLink.

A T node may discover broadcast messages or system messages of a plurality of G nodes by using a device discovery mechanism, and obtain group identifiers, G node identifiers, an identity of an advanced G node, an identity of a general G node, working identities, and the like from the broadcast messages or the system messages of the G nodes.

Specifically, as a discovering party, the T node may screen, based on preset screening information, a G node that the T node is interested in. For example, the screening information may include: a media access control layer identifier, and other device information disclosed by the discovered party, for example, a group identifier, an identity of an advanced G node, an identity of a general G node, and a working identity.

Therefore, for the active-standby mode, the T node may determine an active node and a standby node in the group based on the foregoing filtering information. In an optional implementation, if an election manner is used, the T node may select a G node with a large round number for access, and mark the G node as the active node. In the active-active mode, the T node may access, based on a same group identifier, at least two G nodes that belong to a same node group.

(3) G-T transport channel (or referred to as a communication link) management phase.

According to different working modes of a node group, a transport channel used for service management between G-T may perform operations such as establishment, release, reconfiguration, or switching by using a connection management function unit of a basic service layer. The transport channel between a G node and a T node is an example of the communication sublink in embodiments of this application. For a manner of establishing the transport channel, refer to related descriptions of the second node 12-1 and the second node 12-2 in FIG. 6.

The following separately describes a detailed process of the communication method in embodiments of this application with reference to a G-T transport channel management manner in an active-standby mode and two G-T transport channel management manners in an active-active mode.

(3-1) G-T transport channel management manner in the active-standby mode:

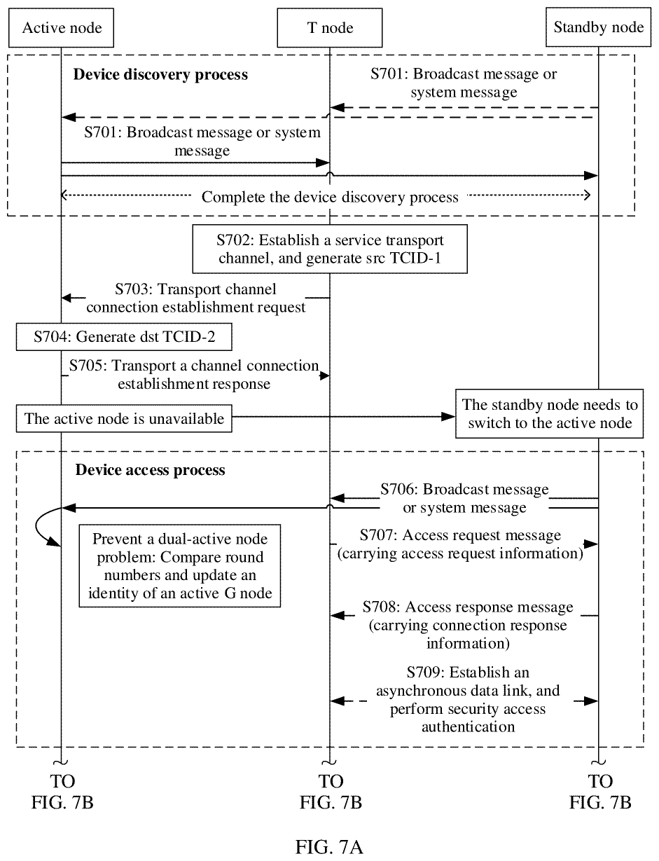

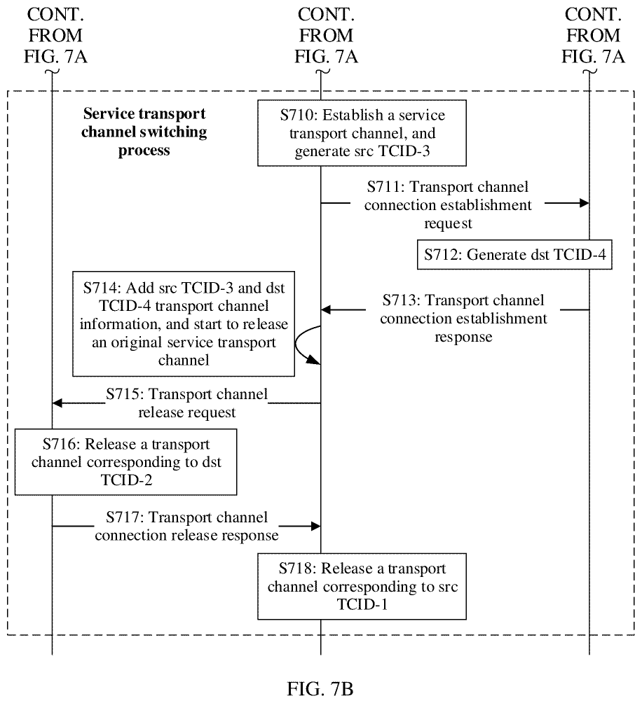

In the active-standby mode, the T node initially establishes a transport channel with an active G node based on a G-T connection management process and performs data transmission, and the T node does not establish a transport channel with a standby G node. When the active G node is unavailable, the standby G node needs to switch an active-standby state, and switches from the standby node to the active node, to replace the original active G node to perform data transmission between the T node and a destination node. As shown in FIG. 7A and FIG. 7B, a G-T transport channel management process in the active-standby mode may include the following steps.

S701: At least two G nodes that belong to a same node group, for example, an active node and a standby node, serve as discovered parties and disclose identity information of the G nodes by using broadcast messages or system messages. The broadcast message or the system message may include at least one of the following information of the node: a device name, a communication address, an identifier of a supported service capability, or service data information that describes the service capability, where the service data information may include at least a group identifier of a node group to which the G node belongs, a working identity of the G node, and the like. Correspondingly, the T node or another G node may receive the broadcast message or the system message, complete a device discovery process, and determine a working identity of each G node in a same node group.

It should be noted that, S701 is an optional step, and only indicates that in the active-standby mode, each G node in the node group may perform this step, so that the G node is discovered by the T node or another G node. A sequence of performing S701 by the G nodes is not limited. In some embodiments, messages in S701 and S706 performed by the standby node may be a same message, and the standby node may perform S706 when determining that the active node is unavailable.

S702: The T node establishes a transport channel (or referred to as a communication link), and generates a source channel identifier of the transport channel, which is represented as src TCID-1.

S703: The T node sends a transport channel connection establishment request message to the active node, where the request message may carry src TCID-1.

S704: The active node agrees to establish the transport channel, and generates a destination channel identifier of the transport channel, which is represented as dst TCID-2.

S705: The active node sends a transport channel connection establishment response message to the T node, where the response message may carry dst TCID-2.

It should be understood that, in embodiments of this application, the source channel identifier is a transport channel identifier carried in a request message sent by a requester to a responder, and “source” indicates a transmission direction of a message carrying the channel identifier, that is, from the requester to the responder. The requester is not limited to a source node of data. Similarly, the destination channel identifier is a transport channel identifier carried in a response message fed back by the responder to the requester, and “destination” indicates a transmission direction of a message carrying the channel identifier, that is, from the responder to the requester. The responder is not limited to a destination node of the data, and src TCID-1 and dst TCID-2 indicate identifiers of the transport channel established between the two parties.

In addition, the T node may locally maintain TCID mapping information between the T node and each G node in the group as communication link information. The G nodes may send active-standby heartbeat packets on a multi-domain coordination and management transport channel to maintain an active-standby relationship. In an optional implementation, based on an application service requirement, a horizontal data backup channel (TCID=TBD) may be established between the G nodes. For example, in a wireless BMS system, the G nodes in the G-group are deployed on different BCUs, and full service data of the BCUs needs to be periodically synchronized between the G nodes.

When the active node is unavailable (for example, an MDC is shut down or the BCU is damaged), the standby node detects that the active node is unavailable based on the active-standby heartbeat packet. In this case, the standby node may upgrade from a general G node identity to an advanced G node identity, and is responsible for G-T air interface transmission resource management. In addition, the standby node needs to perform active-standby state switching, to switch from the standby node to the active node, and replace the original active node for data transmission. In this case, as shown in FIG. 7A and FIG. 7B, the G-T transport channel management process in the active-standby mode may further include the following steps performed in a device access process and steps performed in a service transport channel switching process.

S706: The standby node sends the broadcast message or the system message. The broadcast message or the system message may include indication information. The indication information may include, for example, a group identifier of a node group to which the standby node belongs and a round number that is of the standby node and that is used to elect (elect) the active node.

Correspondingly, in one aspect, as the discovering party, the T node may determine, based on received indication information, whether the standby node can switch the active-standby state. When the standby node is allowed to switch the active-standby state, in S707, the T node sends a connection request message to the original standby node, to request to establish a communication link with the original standby node, and switch the active-standby state for the standby node, so that the standby node switches to the active node.

In another aspect, to prevent a problem of dual-active nodes, the original active node may also serve as the discovering party to listen to the broadcast message or the system message of the original standby node, to identify the round number. When finding that the round number sent by the original standby node is higher than a round number locally maintained by the original active node, the active node automatically switches to the standby node.

S707: The T node sends a connection request message to the standby node, where the connection request message carries connection request information and is used to request to access the standby node.

S708: The standby node feeds back a connection response message to the T node, where the connection response message carries connection response information, and is used to make an access response to the T node.

S709: The T node establishes an asynchronous data link with the standby node, and performs security access authentication.

S710: The T node establishes a transport channel between the T node and the standby node, and generates a source channel identifier of the transport channel, which is represented as src TCID-3.

S711: The T node sends the transport channel connection establishment request message to the standby node, where the request message may carry src TCID-3.

S712: The standby node agrees to establish the transport channel, and generates a destination channel identifier of the transport channel, which is represented as dst TCID-4.

S713: The standby node sends a transport channel connection establishment response message to the T node, where the response message may carry dst TCID-4.

S714: The T node adds src TCID-3 and dst TCID-4 to locally maintained TCID mapping information, and starts to release a service transport channel between the T node and the original active node.

S715: The T node sends a transport channel release request message to the original active node, where the release request message carries dst TCID-2 and indicates to release a transport channel corresponding to dst TCID-2.

S716: The original active node releases the transport channel corresponding to dst TCID-2.

S717: The original active node sends a transport channel release response message to the T node, where the transport channel release response message indicates that the transport channel corresponding to dst TCID-2 is released.

S718: The T node receives the transport channel release response message from the original active node, and releases a transport channel corresponding to src TCID-1.

Therefore, the active-standby state switching process is completed between the T node and the active and standby nodes.

### (3-2) G-T Transport Channel Management Manner in the Active-Active Mode:

In the active-active mode, the T node may establish transport channels with all G nodes (for example, represented as active_G nodes) in the G-group based on a GT connection management procedure, locally maintains TCID mapping information, and records information about communication links between the T node and the nodes in the G-group. The service data may be redundantly transmitted between the T node and the destination node through all active_G nodes, or the T node may flexibly select a communication link to transmit the service data. In an optional implementation, based on an application service requirement, a horizontal data backup channel (TCID=TBD) may alternatively be established between the G nodes. For example, in a wireless BMS system, the G nodes in the G-group are deployed on different BCUs, and full service data of the BCUs needs to be periodically synchronized between the G nodes.

In an unavailable case 1: When an active_G node is unavailable, the T node may normally send the service data to other active_G nodes, to maintain normal application. In addition, the T node deletes, from the local TCID mapping information, TCID information associated with an unavailable communication link.

In an unavailable case 2: When a link between the T node and an active_G node is disconnected or service quality of the link deteriorates (for example, in multi-G node deployment scenarios such as a factory, a home, or a street), the T node may normally send the service data to other active_G nodes, to maintain normal application. In addition, the T node deletes, from the local TCID mapping information, the TCID mapping information associated with the unavailable communication link.

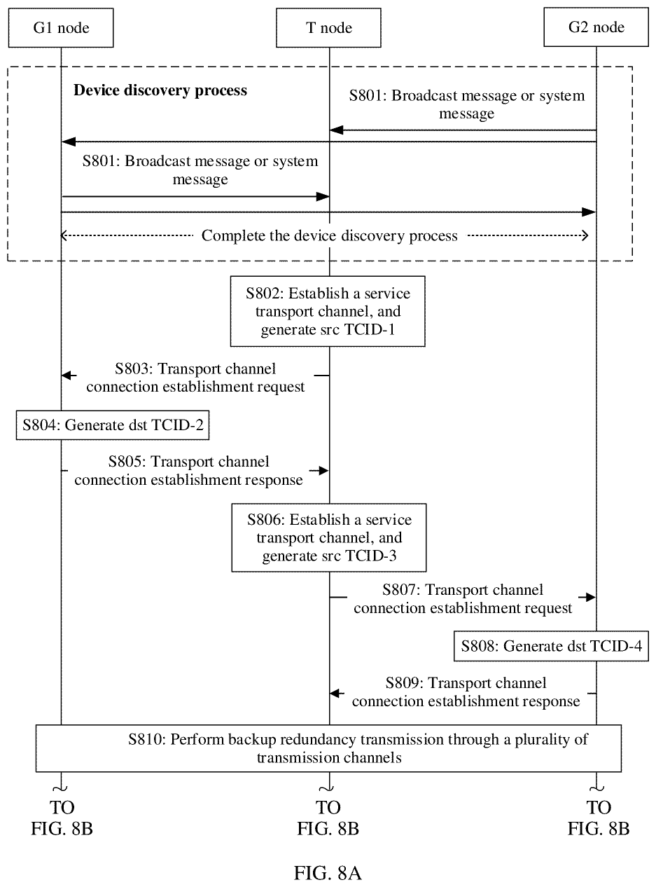

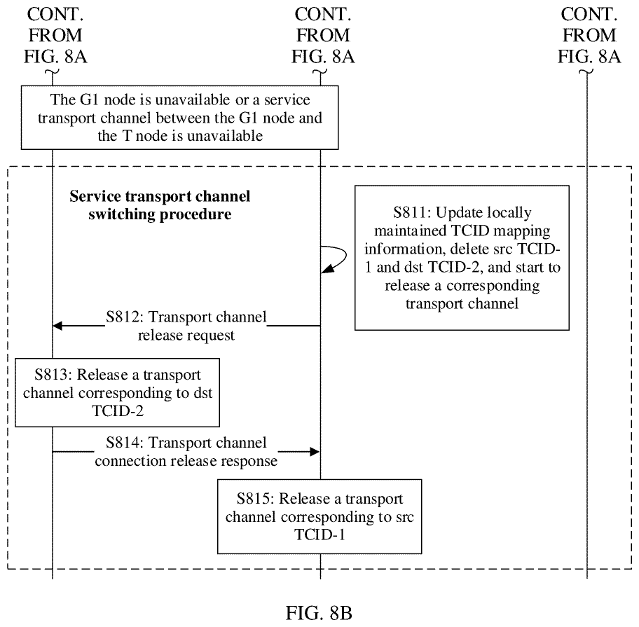

For example, one G-group includes two active_G nodes (represented as an active_G1 node and an active_G2 node, or may be referred to as a G1 node and a G2 node for short). As shown in FIG. 8A and FIG. 8B, a G-T transport channel management process in the active-active mode may include the following steps.

S801: At least two G nodes that belong to a same node group, for example, the G1 node and the G2 node, serve as discovered parties and disclose identity information of the G1 node and the G2 node by using broadcast messages or system messages. The broadcast message or the system message may include at least one of the following information of the node: a device name, a communication address, an identifier of a supported service capability, or service data information that describes the service capability, where the service data information may include at least a group identifier of a node group to which the G node belongs, a working identity of the G node, and the like. Correspondingly, the T node or another G node may receive the broadcast message or the system message, complete a device discovery process, and determine a working identity of each G node in a same node group.

S802: The T node establishes a transport channel between the T node and the G1 node, and generates a source channel identifier of the transport channel, which is represented as src TCID-1.

S803: The T node sends a transport channel connection establishment request message to the G1 node, where the request message may carry src TCID-1.

S804: The G1 node agrees to establish the transport channel, and generates a destination channel identifier of the transport channel, which is represented as dst TCID-2.

S805: The G1 node sends a transport channel connection establishment response message to the T node, where the response message may carry dst TCID-2.

S806: The T node establishes a transport channel between the T node and the G2 node, and generates a source channel identifier of the transport channel, which is represented as src TCID-3.

S807: The T node sends a transport channel connection establishment request message to the G2 node, where the request message may carry src TCID-3.

S808: The G2 node agrees to establish the transport channel, and generates a destination channel identifier of the transport channel, which is represented as dst TCID-4.

S809: The G2 node sends a transport channel connection establishment response message to the T node, where the response message may carry dst TCID-4.

Therefore, the T node establishes corresponding service transport channels with the two active_G nodes in the G-group. It should be understood that processes of establishing the transport channels by the T node and the two G nodes may be performed synchronously. This is not limited in embodiments of this application.

As described above, in the active-active mode, the T node may select at least one communication link to perform data transmission with the destination node. In the active-active mode shown in (3-2), different implementation steps may be included after S809 based on whether the selected at least one communication link specifically includes all or partial communication links between all G nodes in the node group and the T node. For example, as shown in the following solution (3-2-1) and solution (3-2-2), data transmission is performed with the destination node based on a second communication link.

In a possible implementation (3-2-1), as shown in FIG. 8A and FIG. 8B, after S809, the method may further include the following steps shown in S810 to S815.

S810: The T node performs data transmission with the destination node based on a plurality of transport channels between the T node and the two active_G nodes in the G-group.

When the G1 node fails or a G1-T link is unavailable, the T node releases the communication link with the G1 node, and the following steps performed in a service transport channel switching process are included.

S811: The T node updates the locally maintained TCID mapping information, deletes src TCID-1 and dst TCID-2, and starts to release a corresponding transport channel.

S812: The T node sends a transport channel release request message t TCID-2 to the G1 node, to indicate to release dst TCID-2.

S813: The G1 node releases the transport channel corresponding to dst TCID-2.

S814: The G1 node sends a transport channel release response message to the T node, to indicate that the transport channel corresponding to dst TCID-2 is released.

S815: The T node receives the transport channel release response message from the G1 node, and releases the transport channel corresponding to src TCID-1.

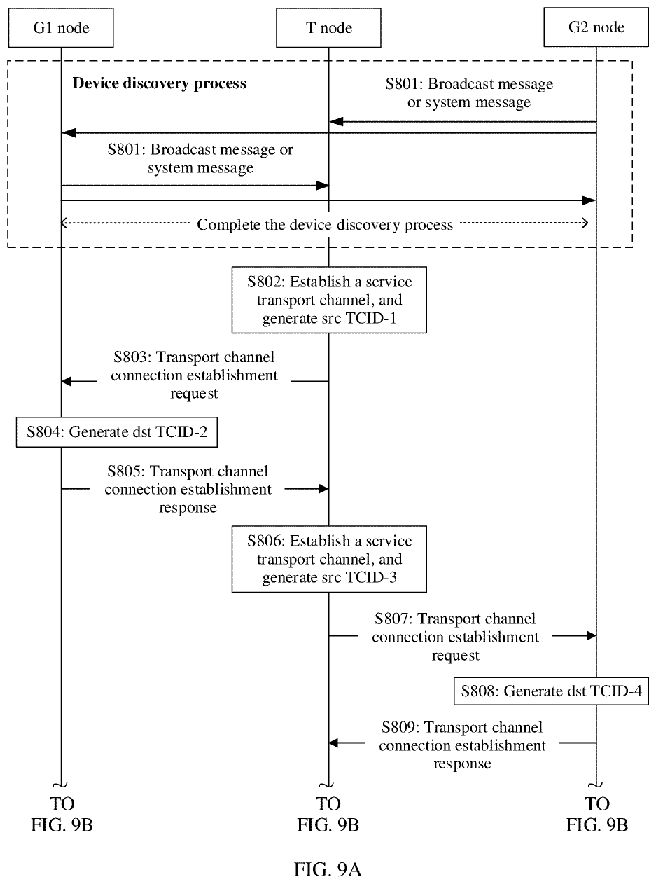

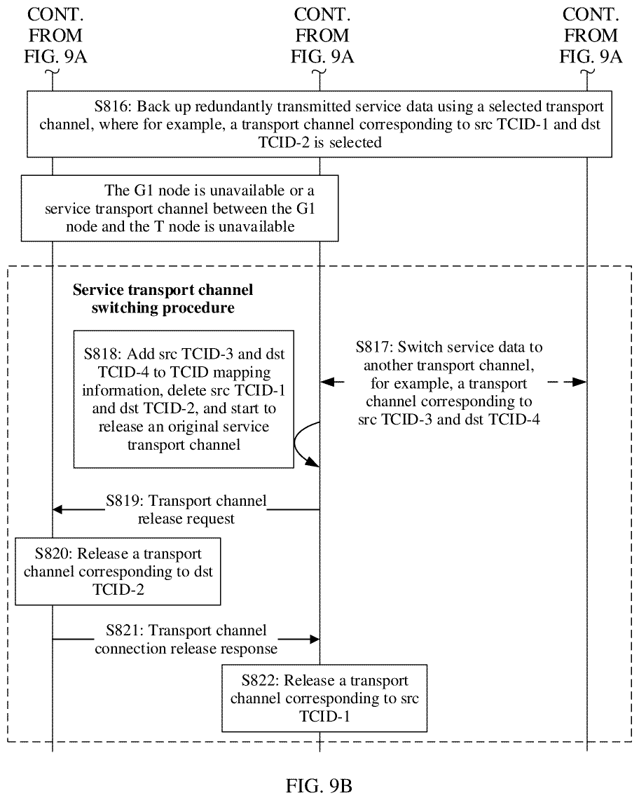

In another possible implementation (3-2-2), as shown in FIG. 9A and FIG. 9B, after S809, the method may further include the following steps shown in S816 to S822.

S816: Based on the service transport channels established between the T node and the two active_G nodes in the G-group, the T node performs redundant transmission using one (or at least one) selected transport channel, where for example, the transport channel corresponding to src TCID-1 and dst TCID-2 is selected. Another unselected transport channel is idle.

When the G1 node is unavailable or the G1-T link is unavailable, that the T node and the G1 node release the unavailable communication link includes the following steps:

S817: The T node switches the service data to another transport channel that is not selected for use in S816, for example, the transport channel corresponding to src TCID-3 and dst TCID-4.

S818: The T node adds src TCID-3 and dst TCID-4 to the locally maintained TCID mapping information, deletes src TCID-1 and dst TCID-2, and starts to release the transport channel corresponding to src TCID-1 and dst TCID-2.

S819: The T node sends a transport channel release request message frame to the G1 node, where the transport channel release request message frame carries dst TCID-2 and indicates to release the transport channel corresponding to dst TCID-2.

S820: The G1 node releases the transport channel corresponding to dst TCID-2.

S821: The G1 node sends a transport channel release response message to the T node, to indicate that the transport channel corresponding to dst TCID-2 is released.

S822: The T node receives the transport channel release response message from the G1 node, and releases the transport channel corresponding to src TCID-1.

Therefore, according to the foregoing method, a communication node in a communication system may be abstracted as a redundant communication networking architecture. In the architecture, a first communication link between a first node and a destination node may have a redundant communication link, for example, a second communication link, and nodes included in the first communication link and nodes included in the second communication link may be different or not be completely the same. When an unavailability problem occurs on the first communication link, for example, when a node included in the first communication link is unavailable or a communication sublink of the first communication link is unavailable, the first node may continue to perform data transmission through the second communication link. This improves reliability of the entire communication system.

It should be noted that, in the solutions shown in (3-1), (3-2-1), and (3-2-2), horizontal data backup may be further performed between different G nodes that belong to a same node group. For example, in the active-standby mode, when the first node performs data transmission with the destination node based on the first communication link, transmitted data may be synchronized to the standby node by using a heartbeat packet sent by the active node, so that the standby node performs backup on the transmitted data. In the active-active mode, data transmitted between the first node and the destination node through any activated node may be sent to another activated node in a destination node group to which the activated node belongs, to perform backup on the transmitted data. In embodiments of this application, a third communication technology may be used between nodes that belong to the destination node group. The third communication technology may be wired communication or a third wireless communication technology. This is not limited in embodiments of this application.

### Method Example 1

An embodiment of this application further provides a communication method. The method may be implemented by a first node, a second node, a third node, and a destination node. In the method example 1, the first node represents the T node in the methods shown in FIG. 7A to FIG. 9B, the second node represents the active node or the activated node that is detected to be unavailable in the methods shown in FIG. 7A to FIG. 9B, and the third node represents the standby node or the available activated node in the methods shown in FIG. 7A to FIG. 9B.

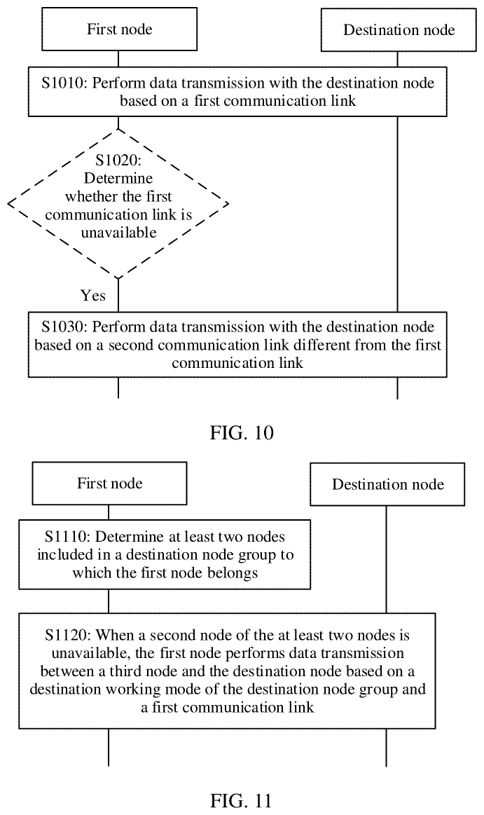

As shown in FIG. 10, the method may include the following steps.

S1010: The first node performs data transmission with the destination node based on a first communication link. The first communication link may include the second node.

S1020: The first node determines whether the first communication link is unavailable. This step is optional. The first node may learn, in any manner, whether the first communication link is available.

The first communication link includes a communication sublink between the first node and the second node, and a communication sublink between the second node and the destination node. That the first communication link is unavailable may include any one of the following: the second node is unavailable; in the first communication link, the communication sublink between the first node and the second node is unavailable; and in the first communication link, the communication sublink between the second node and the destination node is unavailable.

S1030: When determining that the first communication link is unavailable, the first node performs data transmission with the destination node based on a second communication link different from the first communication link.

The second communication link is a redundant communication link of the first communication link, and nodes included in the first communication link and the second communication link are not completely the same. For example, in addition to the second node, the first communication link may further include the first node and the destination node. The second communication link may include the first node and the destination node. In addition, the second communication link may further include the third node. The third node and the second node are different nodes that belong to a destination node group. It should be understood that the destination node group does not include the first node or the destination node, and a node included in the destination node group may be configured to establish a communication connection between the first node and the destination node.

A working mode of the destination node group may include any one of the following: an active-standby mode or an active-active mode. In different working modes, different nodes included in the destination node group may provide at least one communication link between the first node and the destination node. Based on the working mode of the destination node group or a working identity of the node included in the destination node group, data transmission or redundant transmission may be performed between the first node and the destination node based on the at least one communication link, to ensure service continuity.

In embodiments of this application, specific implementation processes of S1010 to S1030 may be different in different working modes of the destination node group.

For example, in the active-standby mode, the second node is an active node, and the third node is a standby node. Before S1030 is implemented, the first node may receive first indication information from the third node, where the first indication information is used to request to switch an active-standby state for the third node. When determining, based on the first indication information, to allow the third node to switch from the standby node to the active node, the first node sends a connection request message to the third node, where the connection request message is used to request to establish a communication sublink with the third node, and the second communication link includes the communication sublink between the first node and the third node. Correspondingly, the third node may receive the connection request message from the first node, and feed back a connection response message to the first node, to establish the communication sublink between the first node and the third node. Further, the first node updates, based on the communication sublink between the first node and the third node, locally maintained communication link information and releases the communication sublink between the first node and the second node.

It may be understood that, in a same node group, there may be at least one standby node, and the third node may be any one of the at least one standby node. The first node may determine, based on the first indication information from the at least one standby node, a standby node that can switch to the active node, and send the connection request message to the standby node, to establish a communication sublink with the standby node.

It may be understood that, in embodiments of this application, the standby node in the destination node group may switch the active-standby state in an election manner. Based on the election manner, the first indication information from the standby node may include a group identifier of the destination node group to which the standby node belongs and a round number that is of the standby node and that is used for active node election. The first node may determine, based on the group identifier, the destination node group to which the standby node belongs, and the first node may select, according to a preset election policy and based on a round number of each standby node, for example, a standby node with a large round number as a new active node. In an optional implementation, the first indication information may be included in a broadcast message or a system message from the standby node, and the broadcast message or the system message may further include at least one of the following information of the standby node: a device name, a communication address, an identifier of a supported service capability, or service data information that describes the service capability. For detailed implementation, refer to the foregoing related descriptions.

For another example, in the active-active mode, before S1010 is implemented, the first node may receive second indication information from at least two nodes in the destination node group, where the at least two nodes include the second node and the third node, and the second indication information may include a group identifier of a node group to which the node belongs and a node identifier of the node. The first node may establish communication sublinks with the at least two nodes based on the second indication information. In addition, the first node may further store communication link information of the first node (for example, the foregoing described TCIP mapping information table) based on availability of the communication sublinks between the first node and the at least two nodes.

When S1010 is implemented, the communication link of the first node may include at least one communication link, each communication link includes a communication sublink that may be established between the first node and a node in the destination node group, and the first node may perform data transmission with the destination node based on the communication sublink. Alternatively, the communication link of the first node may be one communication link, and the communication link includes one communication sublink (for example, a communication sublink between the second node and the first node) established between the first node and at least two nodes in the destination node group, and the first node may perform data transmission with the destination node based on the first communication link.

When the second node is unavailable, the communication sublink between the first node and the second node is unavailable, or the communication sublink between the second node and the destination node is unavailable, the first node may perform data transmission with the destination node based on the communication sublink (included in the second communication link) between the first node and the third node. In addition, the first node may further update the communication link information of the first node based on availability of the communication sublink between the first node and the second node and availability of the communication sublink between the first node and the third node, for example, delete link information of the communication sublink between the first node and the second node.

In an optional implementation, a wired communication technology or a first wireless communication technology may be used for the communication sublink between the first node and the second node. In another optional implementation, a second wireless communication technology may be used for the communication sublink between the first node and the third node. The first wireless communication technology and the second wireless communication technology may be the same or may be different. For example, when being the same, the first wireless communication technology and the second wireless communication technology may be the short-range wireless communication technology specified by SparkLink.

For detailed implementation details, refer to the foregoing related descriptions.

### Method Example 2

An embodiment of this application further provides a communication method. The method may be implemented by a first node, a second node, a third node, and a destination node. In the method example 2, the first node represents the standby node or the available activated node in the methods shown in FIG. 7A to FIG. 9B, the second node represents the active node or the activated node that is detected to be unavailable in the methods shown in FIG. 7A to FIG. 9B, and the third node represents the first node in the methods shown in FIG. 7A to FIG. 9B.

As shown in FIG. 11, the method may include the following steps.

S1110: The first node determines at least two nodes included in a destination node group to which the first node belongs.

In embodiments of this application, a relationship between a node and a node group may be preconfigured. Different nodes may perform a device discovery process based on configuration information of the nodes by using broadcast messages or system messages, to determine whether the nodes belong to a same node group.

In an example, different nodes that belong to a same node group may be configured to be associated with a same group identifier. When S1110 is implemented, the following step may be specifically included: The first node receives first indication information from at least one node, where the first indication information of each node indicates a group identifier of a node group to which the node belongs; and the first node may determine, based on the group identifier in the first indication information, at least one node that belongs to a same destination node group as the first node.

It should be understood that associating different nodes in a same node group based on a group identifier is merely an example of a configuration implementation rather than any limitation. In another embodiment, different nodes may further implement group association based on other information, for example, a service identifier and location information.

Optionally, the first indication information of each node may further indicate a service capability of the node. When S1110 is implemented, nodes that belong to a same node group may further perform an identity negotiation process, to negotiate and determine a working mode of the node group and a working identity of each node in the node group. For example, the first node may perform a service discovery operation with a fourth node in the destination node group based on service capabilities of the at least two nodes included in the destination node group, to determine a working mode of the destination node group, where the fourth node includes a node other than the first node in the destination node group.

A node included in the node group may be used to establish a communication connection for a node outside the group. When the working mode of the node group and the identity of each node in the node group are determined, different nodes included in the node group may establish links with a node (for example, the third node and the destination node) outside the node group based on a requirement and perform data transmission.

S1120: When the second node of the at least two nodes is unavailable, the first node performs data transmission between the third node and the destination node based on the working mode of the destination node group and a first communication link, where the second node is included in a second communication link that is between the third node and the destination node and that is different from the first communication link.

The first communication link is a redundant communication link of the second communication link, and nodes included in the first communication link and the second communication link are not completely the same. For example, in addition to the second node, the second communication link may further include the third node and the destination node. The first communication link may include the third node and the destination node. In addition, the first communication link may further include the first node. The first node and the second node are different nodes that belong to the destination node group. It should be understood that the destination node group does not include the third node and the destination node.

The working mode of the destination node group may include any one of the following: an active-standby mode and an active-active mode.

When the working mode is the active-standby mode, the second node is an active node, the first node is a standby node. When S1120 is implemented, and when the second node of the at least two nodes is unavailable, the first node may send second indication information to the third node, where the second indication information is used to request to switch an active-standby state for the first node. Correspondingly, when the third node determines to allow the first node to switch the active-standby state, the third node may send a connection request message to the first node, to request to establish a communication link with the first node. The first node may receive the connection request message from the third node and feed back a connection response message, to establish the communication link between the first node and the third node. Optionally, the standby node in the destination node group may switch the active-standby state in an election manner, and the second indication information may include a group identifier of the destination node group and a round number that is of the first node and that is used for active node election. Optionally, the second indication information is included in a broadcast message or a system message of the first node, and the broadcast message or the system message of the first node further includes at least one of the following information of the first node: a device name, a communication address, an identifier of a supported service capability, or service data information that describes the service capability. For downward implementation details, refer to the foregoing related descriptions.

When the working mode is the active-active mode, before S1120 is implemented, the first node, as any available node in the destination node group, may send third indication information to the third node, where the third indication information is used to request to establish the communication link. Optionally, the third indication information includes the group identifier of the destination node group and a node identifier of the first node. Optionally, the third indication information is included in a broadcast message or a system message of the first node, and the broadcast message or the system message of the first node further includes at least one of the following information of the first node: a device name, a communication address, an identifier of a supported service capability, or service data information that describes the service capability. When the second node of the at least two nodes is unavailable, the first node may receive a release request message from the third node, where the release request message indicates a to-be-released communication sublink. The first node may perform a release operation based on the release request message from the third node, to release an unavailable communication sublink, for example, a communication sublink between the second node and the third node.

In an optional implementation, a first communication technology is used for the communication sublink between the second node and the third node, and the first communication technology may be a wired communication technology or a first wireless communication technology. In another optional implementation, a second communication technology is used for a communication sublink between the first node and the third node, and the second communication technology may be a second wireless communication technology. The first wireless communication technology and the second wireless communication technology may be the same or may be different. For example, when being the same, the first wireless communication technology and the second wireless communication technology may be the short-range wireless communication technology specified by SparkLink.

For detailed implementation details, refer to the foregoing related descriptions.

An embodiment of this application further provides a communication apparatus, configured to perform the communication method performed by the first node or any second node in the foregoing method embodiments. For related features, refer to the foregoing method embodiments.

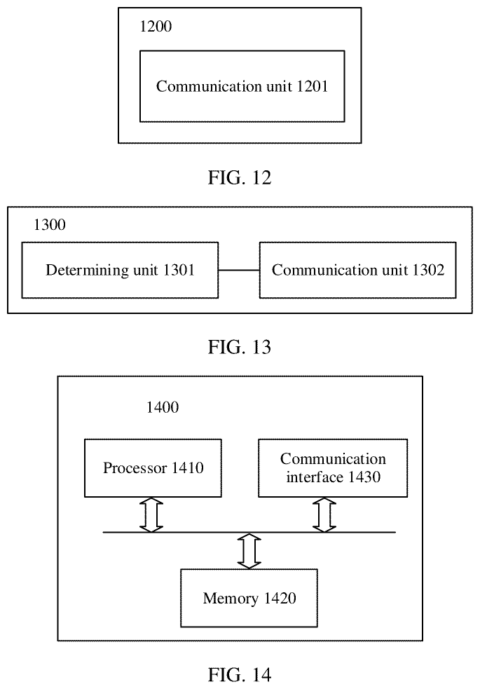

As shown in FIG. 12, an apparatus 1200 may be configured to perform the communication method performed by the first node. The first node may be the first node in the systems shown in FIG. 1, FIG. 2a, FIG. 2b, and FIG. 3. The apparatus 1200 may include a communication unit 1201, configured to: perform data transmission with a destination node based on a first communication link, where the first communication link includes a second node; and when the first communication link is unavailable, perform data transmission with the destination node based on a second communication link different from the first communication link, where the second communication link includes a third node different from the second node, the second node and the third node belong to a destination node group, and a node included in the destination node group is configured to establish a communication connection for a first node and the destination node. For a specific implementation, refer to the detailed descriptions in embodiments shown in FIG. 1 to FIG. 11.

As shown in FIG. 13, an apparatus 1300 may be configured to perform the method performed by the first node. The first node may be any second node in the systems shown in FIG. 1, FIG. 2a, FIG. 2b, and FIG. 3. The apparatus 1300 may include a determining unit 1301, configured to determine at least two nodes included in a destination node group to which the first node belongs; and a communication unit 1302, configured to: when a second node of the at least two nodes is unavailable, perform data transmission between a third node and a destination node based on a working mode of the destination node group and a first communication link, where the second node is included in a second communication link that is between the third node and the destination node and that is different from the first communication link, and the at least two nodes in the destination node group are configured to establish a communication connection for the third node and the destination node. For a specific implementation, refer to the detailed descriptions in embodiments shown in FIG. 1 to FIG. 11.

It should be noted that, in embodiments of this application, unit division is an example, and is merely logical function division. In actual implementation, another division manner may be used. In addition, functional units in this embodiment of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to some solutions, or all or some of the technical solutions may be implemented in the form of a software product. The software product is stored in a storage medium and includes several instructions for instructing a computer device (which may be a personal computer, a server, or a network device) or a processor to perform all or some of the steps of the methods described in embodiments of this application. The storage medium includes any medium that can store program code, for example, a USB flash drive, a removable hard disk, a read-only memory (ROM), a random access memory (RAM), a magnetic disk, or an optical disc.

In a simple embodiment, a person skilled in the art may figure out that all the communication apparatuses in the foregoing embodiments may use the form shown in FIG. 14.

An apparatus 1400 shown in FIG. 14 includes at least one processor 1410 and a memory 1420, and optionally, may further include a communication interface 1430.

In this embodiment of this application, a specific connection medium between the processor 1410 and the memory 1420 is not limited.

In the apparatus shown in FIG. 14, when communicating with another device, the processor 1410 may perform data transmission through the communication interface 1430.

When the communication apparatus uses the form shown in FIG. 14, the processor 1410 in FIG. 14 may invoke computer executable instructions stored in the memory 1420, so that the device 1400 can perform the method performed by the communication apparatus in any one of the foregoing method embodiments.

An embodiment of this application further relates to a chip system. The chip system includes a processor, configured to invoke a computer program or computer instructions stored in a memory, so that the processor performs the method in any one of the foregoing method embodiments.

In a possible implementation, the processor is coupled to the memory through an interface.

In a possible implementation, the chip system further includes the memory, and the memory stores the computer program or the computer instructions.

An embodiment of this application further relates to a computer-readable storage medium. The computer-readable storage medium stores program code, and when the program code is run on a computer, the computer is enabled to perform the method in any one of the foregoing method embodiments.

An embodiment of this application further relates to a computer program product. When the computer program product runs on a computer, the computer is enabled to perform the method in any one of the foregoing method embodiments.

An embodiment of this application further relates to a processor. The processor is configured to invoke a computer program or computer instructions stored in a memory, so that the processor performs the method in any one of the foregoing method embodiments.

The processor mentioned anywhere above may be a general-purpose central processing unit, a microprocessor, an application-specific integrated circuit (ASIC), or one or more integrated circuits configured to control execution of a program of the method in any one of the foregoing method embodiments. The memory mentioned anywhere above may be a read-only memory (ROM), another type of static storage device that can store static information and instructions, a random access memory (RAM), or the like.

It should be understood that embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, an optical memory, and the like) that include computer-usable program code.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

A person skilled in the art can make various modifications and variations to embodiments of this application without departing from the scope of embodiments of this application. In this case, this application is intended to cover these modifications and variations of embodiments of this application provided that they fall within the scope of protection defined by the following claims and their equivalent technologies.

1. A communication method, comprising:
performing, by a first node, data transmission with a destination node based on a first communication link, wherein the first communication link includes a second node; and
in association with the first communication link being unavailable, performing, by the first node, data transmission with the destination node based on a second communication link different from the first communication link, wherein
the second communication link includes a third node different from the second node,
the second node and the third node belong to a destination node group, and
a node included in the destination node group is configured to establish a communication connection for the first node and the destination node.

2. The method according to claim 1, wherein the first communication link being unavailable is represented by at least one of:
the second node is unavailable;
in the first communication link, a communication sublink between the first node and the second node is unavailable; and
in the first communication link, a communication sublink between the second node and the destination node is unavailable.

3. The method according to claim 1, wherein a working mode of the destination node group is an active-standby mode, and the method further comprises:
receiving, by the first node, first indication information from the third node, wherein the first indication information is used to request switching an active-standby state for the third node; and
in association with determining to allow the third node to switch from a standby node to an active node, sending, by the first node, a connection request message to the third node, wherein the connection request message is used to request establishing a communication sublink with the third node, and the second communication link includes the communication sublink between the first node and the third node.

4. The method according to claim 3, wherein the first indication information includes a group identifier of the destination node group, and a round number of the third node used for active node election.

5. The method according to claim 3, wherein the first indication information is included in a broadcast message or a system message from the third node, and the broadcast message or the system message further comprises information of the third node including at least one of: a device name, a communication address, an identifier of a supported service capability, or service data information describing the service capability.

6. The method according to claim 1, wherein a working mode of the destination node group is an active-active mode, and before performing, by the first node, the data transmission with the destination node, the method further comprises:
receiving, by the first node, second indication information from at least two nodes in the destination node group, wherein the at least two nodes include the second node and the third node; and
establishing, by the first node, communication sublinks with the at least two nodes based on the second indication information.

7. The method according to claim 6, wherein the second indication information from each of the at least two nodes includes a group identifier of the destination node group, and a node identifier of the node.

8. The method according to claim 6, wherein the second indication information is included in a broadcast message or a system message from the node, and the broadcast message or the system message of the node further comprises information of the node including at least one of: a device name, a communication address, an identifier of a supported service capability, or service data information describing the service capability.

9. The method according to claim 1, further comprising:
updating, by the first node, communication link information of the first node based on availability of the communication sublink between the first node and the second node, and availability of the communication sublink between the first node and the third node.

10. The method according to claim 1, wherein the communication sublink between the first node and the second node utilizes a first communication technology, and the first communication technology is a wired communication technology or a first wireless communication technology.

11. The method according to claim 10, wherein the communication sublink between the first node and the third node utilizes a second communication technology, and the second communication technology is a second wireless communication technology different from the first wireless communication technology.

12. A communication apparatus, comprising:
at least one processor; and
an interface circuit, wherein the interface circuit is configured to provide data or code instructions for the at least one processor that, when executed by the at least one processor, cause the communication apparatus to:
perform data transmission with a destination node based on a first communication link, wherein the first communication link includes a second node; and
in association with the first communication link being unavailable, perform data transmission with the destination node based on a second communication link different from the first communication link, wherein
the second communication link includes a third node different from the second node,
the second node and the third node belong to a destination node group, and
a node included in the destination node group is configured to establish a communication connection for the communication apparatus and the destination node.

13. The communication apparatus according to claim 12, wherein the first communication link being unavailable is represented by at least one of:
the second node is unavailable;
in the first communication link, a communication sublink between the communication apparatus and the second node is unavailable; and
in the first communication link, a communication sublink between the second node and the destination node is unavailable.

14. The communication apparatus according to claim 12, wherein a working mode of the destination node group is an active-standby mode, and the communication apparatus is further caused to:
receive first indication information from the third node, wherein the first indication information is used to request switching an active-standby state for the third node; and
in association with determining to allow the third node to switch from a standby node to an active node, send a connection request message to the third node, wherein the connection request message is used to request establishing a communication sublink with the third node, and the second communication link includes the communication sublink between the communication apparatus and the third node.

15. The communication apparatus according to claim 14, wherein the first indication information includes a group identifier of the destination node group, and a round number of the third node used for active node election.

16. The communication apparatus according to claim 14, wherein the first indication information is included in a broadcast message or a system message from the third node, and the broadcast message or the system message further comprises information of the third node including at least one of: a device name, a communication address, an identifier of a supported service capability, or service data information describing the service capability.

17. The communication apparatus according to claim 12, wherein a working mode of the destination node group is an active-active mode, and the communication apparatus is further caused to:
receive second indication information from at least two nodes in the destination node group, wherein the at least two nodes include the second node and the third node; and
establish communication sublinks with the at least two nodes based on the second indication information.

18. The communication apparatus according to claim 17, wherein the second indication information from each of the at least two nodes includes a group identifier of the destination node group, and a node identifier of the node.

19. A non-transitory computer-readable storage medium storing a computer program that, when executed by a computer, cause the computer to provide execution comprising:
performing data transmission with a destination node based on a first communication link, wherein the first communication link includes a second node; and
in association with the first communication link being unavailable, performing data transmission with the destination node based on a second communication link different from the first communication link, wherein
the second communication link includes a third node different from the second node,
the second node and the third node belong to a destination node group,
and a node included in the destination node group is configured to establish a communication connection for a first node and the destination node.

20. The non-transitory computer-readable storage medium according to claim 19, wherein the first communication link being unavailable is represented by at least one of:
the second node is unavailable;
in the first communication link, a communication sublink between the first node and the second node is unavailable; and
in the first communication link, a communication sublink between the second node and the destination node is unavailable.
